(19) United States
(12) Patent Application Publication
(10) Pub. No.: US 2003/0123198 A1
(43) Pub. Date: Jul. 3, 2003

(54) Magnetic sensor using magneto-resistive effect, a magnetic head using magneto-resistive effect, a magnetic reproducing apparatus, a method of manufacturing a magnetic sensor using magneto-resistive effect and a method of manufacturing a magnetic head using magneto-resistive effect

(76) Inventors: Nobuhiro Sugawara, Miyagi (JP); Masatoshi Yoshikawa, Kanagawa (JP); Hiroyuki Ohmori, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/233,142

(22) Filed: Aug. 30, 2002

(30) Foreign Application Priority Data
Aug. 30, 2001 (JP) P2001-261986

(51) Int. Cl. G11B 5/39

(52) U.S. Cl. 360/314; 148/108; 29/603.08

(57) ABSTRACT

First and second magneto-resistive effect elements (1) and (2) of a current perpendicular to plane type having magnetic flux sensing films are laminated through a nonmagnetic intermediate gap layer (3) in such a manner that their magnetic flux sensing films are located close to each other. Then, magneto-resistive change characteristics are caused to become opposite to each other so that a differential output between the output of the first and second magneto-resistive effect elements may be generated as a magnetic sensor output or a differential output between the output of the first and second magneto-resistive effect elements may be generated as a differential output in an external circuit configuration. In this manner, a resolution can be improved by a configuration in which a gap length, which decides a resolution, may not be restricted by a thickness of a magneto-resistive effect element. Therefore, restrictions imposed on the resolution in the MR magnetic sensor can be improved.

### BACKGROUND OF THE INVENTION

1. Field of the Invention

The present invention relates to a magnetic sensor using magneto-resistive effect, a magnetic head using magneto-resistive effect, a magnetic reproducing apparatus and a method of manufacturing magnetic sensor using magneto-resistive effect and magnetic head using magneto-resistive effect.

2. Description of the Related Art

In recent years, as recording density in a magnetic recording and reproducing apparatus such as an HDD (hard disk drive) increases rapidly, there is an increasing demand for a magnetic head which can record information on a recording medium at high recording density.

As the recording density is increasing as described above, the size of recording bits recorded on a recording medium is being reduced and a signal magnetic field is decreased in accordance with the reduction of the size of the recording bits. A conventional electromagnetic induction type magnetic head which is what might be called a ring core type is able to detect a signal magnetic field generated from a magnetic recording medium on the basis of an electromagnetic induction effect through a ring core. In this case, since this electromagnetic induction type magnetic head is adapted to indirectly detect the signal magnetic field generated from the magnetic recording medium through the ring core, this electromagnetic induction type magnetic head becomes unable to maintain sufficient detection sensitivity.

On the other hand, a magnetic head using magneto-resistive effect which is able to directly sense a signal magnetic field based upon recording information from a magnetic recording medium by making effective use of magneto-resistive effect has received a remarkable attention so far.

This magnetic head using magneto-resistive effect includes a signal magnetic field sensing portion which is able to sense a signal magnetic field from the surface of the magnetic recording medium within a short distance, e.g., directly so that it can reproduce information from the magnetic recording medium at very high sensitivity.

At present, a magnetic head using a spin-valve type giant magneto-resistive effect element (hereinafter simply referred to as an “SV type GMR element”) is available as the main stream of the magnetic head using magneto-resistive effect.

As a fundamental configuration of this SV type GMR element, the SV type GMR element includes a lamination layer film configuration which is comprised of a magnetization fixed layer called a spin layer, a nonmagnetic spacer layer and a magnetization free layer called a free layer.

As this SV type GMR element, there are available an SV type GMR element having a current in plane type in which a sense current flows through the direction of the layer plane, i.e., so-called CIP (current in plane) type configuration and an SV type GMR element having a current perpendicular to plane, i.e., CPP (current perpendicular to plane) type configuration.

FIG. 1, for example, is a schematic cross-sectional view showing a magnetic head using magneto-resistive effect (MR head) including this SV type GMR element or a tunnel type magneto-resistive effect type element, i.e., so-called TMR element as a magnetic sensing portion. As shown in FIG. 1, the magnetic head using magneto-resistive effect has such a configuration that an MR element 100 is disposed between a pair of opposing magnetic shields 101 and 101 through a magnetic gap layer 102.

This MR head 103 has a flying type magnetic head configuration in which it is opposed to a perpendicular magnetization recording medium, e.g., a hard disk 104 and in which it can be flown with a predetermined narrow spacing from the recording medium surface due to an air current produced between the MR head 103 and the hard disk 104 when the MR head 103 and this recording medium 104 are moved relatively to each other.

Then, this magnetic head using magneto-resistive effect is located such that the front end of the MR element 100 may face the surface at which the MR head 103 is opposed to the recording medium 104, i.e., an ABS (air bearing surface) 105.

FIGS. 2A and 2B are diagrams to which reference will be made in explaining reproducing characteristics of a magnetic sensor using magneto-resistive effect or a magnetic head according to the related art. That is, FIG. 2A shows the manner in which this MR head 103 reproduced data, and FIG. 2B shows reproduced output characteristics of this MR head 103. In this case, as the magnetized state is schematically shown by arrows in FIG. 2B, when at least one of the MR head 103 and the recorded signal magnetic domains magnetized perpendicularly to the thickness direction of the perpendicular magnetization recording medium 104 is moved relatively to the other, the output waveform obtained from the MR element 100 varies monotonically relative to the magnetization of the recorded bit signals on the recording medium 104 as shown in FIG. 2A.

Accordingly, in order for this MR head 103 to obtain a reproduced waveform having a similar peak shape to that of the ordinary current in plane magnetic recording when this MR head 103 passes the magnetization transition area, a reproduced signal processing circuit has to include a differentiation circuit.

This differentiation circuit, however, encounter a problem in which noises are increased unavoidably. Moreover, the peak shape, which has been differentiated, tends to be shifted easily. There arise problems that signal error rates will become different from each other and that a signal-to-noise ratio (S/N) will be deteriorated.

Further, a magnetic gap length g which decides a reproduction resolution of the magnetic head having this configuration becomes equal to the spacing between the pair of magnetic shields 101 in the ABS 105 so that this magnetic gap length g cannot be made smaller than the thickness of at least the MR element 100. That is, when this MR element 100 is an SV type GMR element, for example, since this MR element 100 has a thickness ranging from 30 nm to 40 nm, the magnetic gap length g has a length over 30 nm to 40 nm. As a consequence, a reproduction resolution that is not more than those figures cannot be obtained.

However, in recent years, a demand for realizing higher-recording density in the recording medium is increasing, and in accordance with such demand for higher-recording density, a demand for higher reproduction resolution is increasing. Therefore, it is requested that the magnetic gap length g should be reduced.

Furthermore, there arises a problem that a reproduced output will be lowered in level as the recorded bits are reduced in size in accordance with the increase of recording density.

### SUMMARY OF THE INVENTION

In view of the aforesaid aspects, it is an object of the present invention to provide a magnetic sensor using magneto-resistive effect in which a resolution of a reproducing magnetic head, for example, can be improved and a reproduced output can be improved, a magnetic head using such magnetic sensor using magneto-resistive effect and a magnetic reproducing apparatus.

Further, when a resolution of a magnetic sensor is increased, a magnetic sensor according to the present invention can be applied not only to the magnetic head but also to a magnetic scale, for example. A resultant magnetic scale can become high in accuracy.

A magnetic sensor according to the present invention includes a lamination layer structure portion of a magneto-resistive effect element in which first and second magneto-resistive effect elements are laminated through a nonmagnetic intermediate gap layer and wherein a differential output between respective output of the first and second magneto-resistive effect elements is generated as a magnetic sensor output.

This differential output can be obtained by making magneto-resistive change characteristics of the first and second magneto-resistive effect elements become opposite to each other in polarity.

Each of the first and second magneto-resistive effect elements has a configuration in which magnetization free layers made up of ferromagnetic films at least of which the magnetization directions are respectively changed in response to external magnetic fields, nonmagnetic spacer layers and magnetization fixed layers made up of ferromagnetic layers of which the magnetization directions are respectively substantially fixed to predetermined directions are laminated, in that order.

A magnetic head according to the present invention is a magnetic head using magneto-resistive effect including a magnetic sensor using magneto-resistive effect and is able to detect signal magnetic fields based upon recorded information from a perpendicular magnetic recording medium. Its magnetic sensor using magneto-resistive effect has the above-mentioned magnetic sensor configuration according to the present invention.

A magnetic reproducing apparatus according to the present invention is a magnetic reproducing apparatus which includes a magnetic head using magneto-resistive effect having a magnetic sensor capable of detecting signal magnetic fields based upon recorded information from a perpendicular magnetic recording medium. Its magnetic sensor using magneto-resistive effect has the above-mentioned magnetic sensor configuration according to the present invention.

Further, a method of manufacturing a magnetic sensor using magneto-resistive effect according to the present invention is a method of manufacturing a magnetic sensor using magneto-resistive effect including a lamination layer structure portion in which first and second magneto-resistive effect elements are laminated through a nonmagnetic intermediate gap layer. This manufacturing method comprises a deposition process in which a first magneto-resistive effect element is deposited, a nonmagnetic intermediate gap layer is deposited and a second magneto-resistive effect element is deposited, in that order and a process in which magneto-resistive change characteristics of the first and second magneto-resistive effect elements are made opposite to each other in polarity by annealing with application of magnetic fields in one direction, thereby to manufacture a magnetic sensor using magneto-resistive effect.

A method of manufacturing a magnetic sensor using magneto-resistive effect according to the present invention is a method of manufacturing a magnetic sensor using magneto-resistive effect including a lamination layer structure portion of a magneto-resistive effect element in which first and second magneto-resistive effect elements are similarly laminated through a nonmagnetic intermediate gap layer. This manufacturing method comprises a deposition process in which the first magneto-resistive effect element is deposited, the nonmagnetic intermediate gap layer is deposited and the second magneto-resistive effect element is deposited, in that order and a process in which magneto-resistive change characteristics of the first and second magneto-resistive effect elements are made opposite to each other in polarity by annealing with application of magnetic fields based upon application of induced magnetic fields generated when a current flows through the first and second magneto-resistive effect elements in one direction, thereby to manufacture a magnetic sensor using magneto-resistive effect.

Further, in the method of manufacturing the magnetic head using magneto-resistive effect according to the present invention, the magnetic sensor is manufactured by the method of manufacturing the above-mentioned respective magnetic sensor using magneto-resistive effects according to the present invention.

As described above, according to the configuration of the present invention, since the magnetic sensor is comprised of the first and second magneto-resistive effect elements, as will be apparent from the description which will be made later on, a magnetic gap length can be reduced and hence a resolution can be improved.

Since the output of the magnetic sensor is generated as the differential output between the output of the first and second magneto-resistive effect elements, the output can be improved and a peak-like reproduced waveform can be obtained in response to the magnetization transition of the recording bits. Therefore, when a recorded signal is read out from the perpendicular magnetic recording medium, it becomes possible to avoid a signal processing circuit such as the aforementioned differentiation circuit from being used.

### BRIEF DESCRIPTION OF THE DRAWINGS

FIG. 1 is a diagram showing a fundamental configuration of a magnetic head of the present invention using a conventional magnetic sensor using magnetic sensor using magneto-resistive effect

FIGS. 2A and 2B are useful for explaining reproducing characteristics of the conventional magnetic sensor using magneto-resistive effect or magnetic head, wherein

FIG. 2A is a graph showing an output characteristic; and

FIG. 2B is a schematic diagram showing the manner in which reproduction is performed from a perpendicular magnetization recording medium.

FIG. 3 is a diagram schematically showing a fundamental configuration of a magnetic head of the present invention using a magnetic sensor using magneto-resistive effect according to the present invention;

FIGS. 4A and 4B are useful for explaining reproducing characteristics of the magnetic sensor using magneto-resistive effect or the magnetic head according to the present invention, wherein:

FIG. 4A is a graph showing an output characteristic; and

FIG. 4B is a schematic diagram showing the manner in which reproduction is performed from a perpendicular magnetization recording medium.

FIGS. 5A to 5C are useful for explaining output characteristics of the magnetic sensor using magneto-resistive effect or the magnetic head according to the present invention, wherein:

FIGS. 5A and 5B are characteristic curves of first and second magneto-resistive effect elements, respectively; and

FIG. 5C is a diagram showing a synthesized output characteristic curve of the above-mentioned two characteristic curves of FIGS. 5A and 5B;

FIG. 6 is a schematic cross-sectional view of a magnetic sensor (magnetic head using magneto-resistive effect) according to another embodiment of the present invention;

FIG. 7 is a diagram showing characteristics of the first and second magneto-resistive effect elements comprising the magnetic sensor according to the present invention;

FIG. 8 is a characteristic graph showing measured results of relationships between magnetic flux efficiencies and track width of an inventive magnetic shield type magnetic head using magneto-resistive effect and a magnetic shield type magnetic head using magneto-resistive effect having a related-art structure;

FIG. 9 is a schematic front view showing a magnetic sensor (magnetic head using magneto-resistive effect) according to another embodiment of the present invention;

FIG. 10 is a schematic front view showing a magnetic sensor (magnetic head using magneto-resistive effect) according to still another embodiment of the present invention;

FIG. 11 is a schematic front view showing a magnetic sensor (magnetic head using magneto-resistive effect) according to another embodiment of the present invention;

FIG. 12 is a schematic front view showing a magnetic sensor (magnetic head using magneto-resistive effect) according to a further embodiment of the present invention;

FIG. 13 is a schematic cross-sectional view showing a magnetic sensor (magnetic head using magneto-resistive effect) according to a yet further embodiment of the present invention;

FIG. 14 is a schematic cross-sectional view showing a magnetic sensor (magnetic head using magneto-resistive effect) according to a yet further embodiment of the present invention;

FIG. 15 is a schematic cross-sectional view showing a magnetic sensor (magnetic head using magneto-resistive effect) according to a still further embodiment of the present invention;

FIG. 16 is a schematic cross-sectional view showing a magnetic sensor (magnetic head using magneto-resistive effect) according to a still further embodiment of the present invention;

FIG. 17 is a perspective view showing an example of a magnetic recording and/or reproducing apparatus to which a magnetic reproducing apparatus according to the present invention is applied;

FIG. 18 is a perspective view showing an example of an actuator arm of the magnetic recording and/or reproducing apparatus shown in FIG. 17;

FIG. 19 is a pictorial representation to which reference will be made in explaining the magnetization state of the magnetic sensor according to a further embodiment of the present invention;

FIG. 20 is a pictorial representation to which reference will be made in explaining the magnetization state of the magnetic sensor according to a yet further embodiment of the present invention;

FIG. 21 is a pictorial representation to which reference will be made in explaining the magnetization state of the magnetic sensor according to a still further embodiment of the present invention;

FIGS. 22A to 22C are process diagrams of a manufacturing method according to the present invention, respectively;

FIG. 23 is a schematic cross-sectional view showing a magnetic sensor (magnetic head using magneto-resistive effect) according to a further embodiment of the present invention;

FIG. 24 is a schematic cross-sectional view showing a magnetic sensor (magnetic head using magneto-resistive effect) according to a yet further embodiment of the present invention;

FIG. 25 is a schematic cross-sectional view showing a magnetic sensor (magnetic head using magneto-resistive effect) according to a yet further embodiment of the present invention;

FIG. 26 is a schematic cross-sectional view showing a magnetic sensor (magnetic head using magneto-resistive effect) according to a yet further embodiment of the present invention;

FIG. 27 is a schematic cross-sectional view showing a magnetic sensor (magnetic head using magneto-resistive effect) according to a yet further embodiment of the present invention;

FIG. 28 is a schematic cross-sectional view showing a magnetic sensor (magnetic head using magneto-resistive effect) according to a yet further embodiment of the present invention;

FIG. 29 is a schematic cross-sectional view showing a magnetic sensor (magnetic head using magneto-resistive effect) according to a still further embodiment of the present invention;

FIG. 30 is a schematic cross-sectional view showing a magnetic sensor (magnetic head using magneto-resistive effect) according to a still further embodiment of the present invention;

FIG. 31 is a schematic cross-sectional view showing a magnetic sensor (magnetic head using magneto-resistive effect) according to a still further embodiment of the present invention;

FIG. 32 is a perspective view to which reference will be made in explaining a process of a method of manufacturing a magnetic sensor (magnetic head using magneto-resistive effect) according to the present invention;

FIG. 33 is a perspective view to which reference will be made in explaining a process of a method of manufacturing a magnetic sensor (magnetic head using magneto-resistive effect) according to the present invention;

FIG. 34 is a perspective view to which reference will be made in explaining a process of a method of manufacturing a magnetic sensor (magnetic head using magneto-resistive effect) according to the present invention;

FIG. 35 is a perspective view to which reference will be made in explaining a process of a method of manufacturing a magnetic sensor (magnetic head using magneto-resistive effect) according to the present invention;

FIG. 36 is a perspective view to which reference will be made in explaining a process of a method of manufacturing a magnetic sensor (magnetic head using magneto-resistive effect) according to the present invention;

FIG. 37 is a perspective view to which reference will be made in explaining a process of a method of manufacturing a magnetic sensor (magnetic head using magneto-resistive effect) according to the present invention;

FIG. 38 is a perspective view to which reference will be made in explaining a process of a method of manufacturing a magnetic sensor (magnetic head using magneto-resistive effect) according to the present invention;

FIG. 39 is a perspective view to which reference will be made in explaining a process of a method of manufacturing a magnetic sensor (magnetic head using magneto-resistive effect) according to the present invention;

FIG. 40 is a perspective view to which reference will be made in explaining a process of a method of manufacturing a magnetic sensor (magnetic head using magneto-resistive effect) according to the present invention; and

FIG. 41 is a perspective view showing a magnetic head according to another embodiment of the present invention.

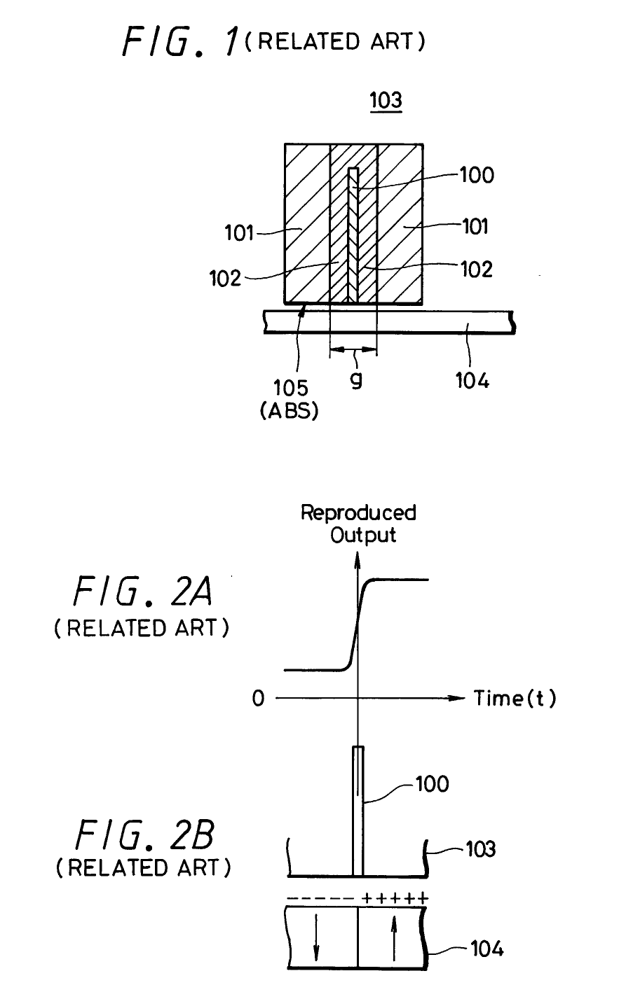

### DESCRIPTION OF THE PREFERRED EMBODIMENTS

A magnetic sensor using magneto-resistive effect, a magnetic head using magneto-resistive effect and a magnetic reproducing apparatus and a method of manufacturing a magnetic sensor using magneto-resistive effect and a method of manufacturing a magnetic head using magneto-resistive effect according to the present invention will now be described below.

[A Magnetic Sensor Using Magneto-resistive Effect and a Magnetic Head Using Magneto-resistive Effect]

A magnetic sensor using magneto-resistive effect can be made up of a magnetic sensor using magneto-resistive effect of a CPP type (current perpendicular to plane type) in which sense current flows through the direction perpendicular to the layer plane of its magneto-resistive effect element, for example.

It is known that the magnetic sensor using magneto-resistive effect having this CPP type configuration can produce a high output and can be easily prevented from being restricted by thermal fluctuation as compared with a magnetic sensor using magneto-resistive effect of a CIP type (current in plane type) in which sense current flows through the direction extended along the layer plane of a magneto-resistive effect element.

A magnetic head using magneto-resistive effect according to the present invention is a magnetic head using magneto-resistive effect including a magnetic sensor using magneto-resistive effect capable of detecting a signal magnetic field based upon recorded information on a perpendicular magnetic recording medium. The magnetic head using magneto-resistive effect according to the present invention is disposed in such a fashion that the layer plane of the above magnetic sensor becomes substantially perpendicular to the surface of the magnetic recording medium.

In the present invention, its magnetic sensor using magneto-resistive effect may have each of magnetic sensors using magneto-resistive effect configurations according to the present invention.

A magnetic sensor using magneto-resistive effect according to the present invention includes a magneto-resistive effect element lamination layer structure portion in which first and second magneto-resistive effect elements are laminated through a nonmagnetic gap layer and generates a differential output of the respective output from the first and second magneto-resistive effect elements.

When the above differential output is generated from the magnetic sensor using magneto-resistive effect, the detected output from the first and second magneto-resistive effect elements can be generated as a differential output in the outside, i.e., from a circuit standpoint. The present invention is not limited thereto and respective magneto-resistive changing characteristics of the first and second magneto-resistive effect elements can be obtained as those of opposite polarity relative to the detection magnetic field, i.e., respective magneto-resistive changing characteristics in which when one magneto-resistive changing characteristic exhibits a characteristic which increases in response to the applied magnetic field, the other magneto-resistive changing characteristic exhibits a characteristic which decreases in response to the applied magnetic field.

The first and second magneto-resistive effect elements have configurations in which magnetization free layers made of ferromagnetic layers whose magnetization directions are changed in response to external magnetic fields, nonmagnetic spacer layers and magnetization fixed layers made of ferromagnetic layers whose magnetization directions are substantially fixed to predetermined directions respectively are laminated, in that order.

Antiferromagnetic layers, which are ferromagnetically exchange-coupled to the magnetization fixed layers, may be laminated on the magnetization fixed layer and the magnetization directions of the magnetization fixed layers may be fixed by the above-mentioned antiferromagnetic layers.

In the lamination layer structure portions of the first and second magneto-resistive effect elements, the respective magnetization free layer sides of the first and second magneto-resistive effect elements are opposed to each other through nonmagnetic intermediate gap layers, e.g., the first magneto-resistive effect element, for example, may have a so-called bottom type configuration, the second magneto-resistive effect element may have a top type configuration and the first and second magneto-resistive effect elements may be laminated through the nonmagnetic intermediate gap layers.

In the lamination layer structure portion in which the first and second magneto-resistive effect elements are laminated on the side of the magnetization free layers as described above, the magnetization fixed layer of one of the first and second magneto-resistive effect elements maybe formed of a single ferromagnetic layer or may have a lamination layer structure made of a plurality of ferromagnetic layers of layers of an odd number based upon a so-called synthetic configuration in which directions of magnetic moments are coupled to each other nearly in an anti-parallel fashion.

Then, the magnetization fixed layer of the other magneto-resistive effect element may have a lamination layer structure of antiferromagnetic layer of layers of an even number having a synthetic configuration in which magnetization directions are coupled to each other nearly in an anti-parallel fashion.

In this manner, in the first and second magneto-resistive effect elements, the magnetization directions of the antiferromagnetic layers which are ferromagnetically-exchange-coupled to the magnetization fixed layers are substantially the same direction, whereby the magneto-resistive change characteristics in the first and second magneto-resistive effect elements may exhibit opposite polarities to each other.

Alternatively, the first and second magneto-resistive effect elements are magneto-resistive effect elements including antiferromagnetic layers, magnetization fixed layers and magnetization free layers. The magnetization fixed layers of the first and second magneto-resistive effect elements include lamination layer structures based upon single layer structures of both ferromagnetic layers, a plurality of ferromagnetic layer structures of an odd number of layers in which directions of magnetic moments are coupled to each other in a nearly anti-parallel fashion or based upon ferromagnetic layer structures of an even number of layers in which directions of magnetic moments are coupled to each other in an anti-parallel fashion.

In this manner, the magnetization directions of the antiferromagnetic layers, which are ferromagnetically exchange-coupled to the magnetization fixed layers of the first and second magneto-resistive effect elements, are made anti-parallel.

The antiferromagnetic layers of the first and second magneto-resistive effect elements can be made different from each other in any one of or both of thickness and composition.

With the above-mentioned configuration, the thicknesses of the antiferromagnetic layers in the first and second magneto-resistive effect elements are changed, whereby temperatures at which exchange-couple magnetic fields of the magnetization fixed layers and the antiferromagnetic layers are lost, i.e., so-called blocking temperatures can be made different from each other. When the blocking temperatures are made different from each other, the magnetization directions of the magnetization fixed layers and the antiferromagnetic layers can be set to anti-parallel, for example, by magnetization fixed annealings of two steps per the magnetization fixed layer. That is, a magnetization fixed annealing of a first step is effected on the element in which the blocking temperature was increased at a predetermined temperature and then a second magnetization fixed annealing is effected at a temperature lower than the temperature in this magnetization fixed annealing.

The first and second magneto-resistive effect elements may have flux guides located at least in the front or rear portion of the lamination layer structure portions.

According to this flux guide, a magnetic flux efficiency can be improved by forming magnetic paths of signal detection magnetic fields which pass the first and second magneto-resistive effect elements and sensitivity of the magneto-resistive change can be improved.

As described above, although the magneto-resistive change characteristics can be made opposite to each other in characteristic by the configurations of the lamination layer structure portions of the first and second magneto-resistive effect elements, the first and second magneto-resistive effect elements may have magneto-resistive change characteristics of the same polarity relative to the applied magnetic field, and the differential output between the respective output of the first and second magneto-resistive effect elements can be generated as the magnetic sensor output from a circuit standpoint.

When the first and second magneto-resistive effect elements are laminated through the nonmagnetic intermediate gap layer at their magnetization free layer sides, the thicknesses of these magnetization free layers can be made smaller than that of the nonmagnetic intermediate gap layer. With this configuration, magnetic flux can be captured satisfactorily in accordance with the size of recording bits of a magnetic signal detected material from which a magnetic signal is read out.

By selecting the thicknesses of the respective magnetization free layers of the first and second magneto-resistive effect elements each other, so-called magnetization volumes (saturated magnetization Ms×thickness) of these magnetization free layers can be selected each other arbitrarily and symmetry of operations can be maintained.

In the magnetic head using magneto-resistive effect according to the present invention, the thickness of its nonmagnetic intermediate gap layer, for example, can be reduced at its surface in which it is opposed to the above-described magnetic recording medium as compared with that of its rear portion.

Moreover, as described above, when its magnetic sensor has the above-mentioned configuration in which the first and second magnetization free layers are laminated across the nonmagnetic intermediate gap layer, the tip end of the nonmagnetic intermediate gap layer and the tip ends of the magnetization free layers of the adjacent first and second magneto-resistive effect elements located across the nonmagnetic intermediate gap layer can be projected forward from the magnetization fixed layers and the nonmagnetic spacer layers of the first and second magneto-resistive effect elements.

[Magnetic Reproducing Apparatus]

This magnetic reproducing apparatus is a magnetic reproducing apparatus which includes a magnetic head using magneto-resistive effect having a magnetic sensor capable of detecting signal magnetic fields based upon recorded information from a perpendicular magnetic recording medium. Its magnetic sensor using magneto-resistive effect has the above-mentioned configuration of the respective magnetic sensor using magneto-resistive effects according to the present invention.

[Method of Manufacturing a Magnetic Sensor Using Magneto-resistive Effect and a Magnetic Sensor Using Magneto-resistive Effect]

A method of manufacturing a magnetic sensor using magneto-resistive effect according to the present invention comprises the step of the film deposition process in which the first magneto-resistive effect element is deposited, the nonmagnetic intermediate gap layer is deposited and the second magneto-resistive effect element is deposited, in that order and the process in which the magnetization directions are set to the same direction simultaneously by annealing with application of magnetic fields in one direction as described above when it is intended to set the magnetization directions of the antiferromagnetic layers of the first and second magneto-resistive effect elements to the same direction.

As described above, when the antiferromagnetic layers of the first and second magneto-resistive effect elements are magnetized in the anti-parallel direction, after the process for depositing the first magneto-resistive effect element, the nonmagnetic intermediate gap layer and the second magneto-resistive effect element, in that order, the respective antiferromagnetic layers are magnetized in an anti-parallel fashion by annealing with application of magnetic fields generated with application of induced magnetic fields obtained when current flows through the magnetic sensor in one direction.

Further, when the blocking temperatures of the magnetization fixed layers of the two magneto-resistive effect elements are made different from each other, in order to fix these magnetizations, the first and second magneto-resistive effect elements are treated by the fixing annealings of two stages and thereby the magnetization directions of both of the first and second magneto-resistive effect elements can be set to anti-parallel, for example.

According to the method of manufacturing the magnetic head using magneto-resistive effect, the method of manufacturing the magnetic sensor using magneto-resistive effect in the respective magnetic heads using magneto-resistive effects can be realized with application of the method of manufacturing the above-mentioned respective magnetic sensors using magneto-resistive effect.

[Description of Operations]

Next, fundamental operations of the magnetic sensor using magneto-resistive effect according to the present invention and the magnetic head using magneto-resistive effect according to the present invention will be described.

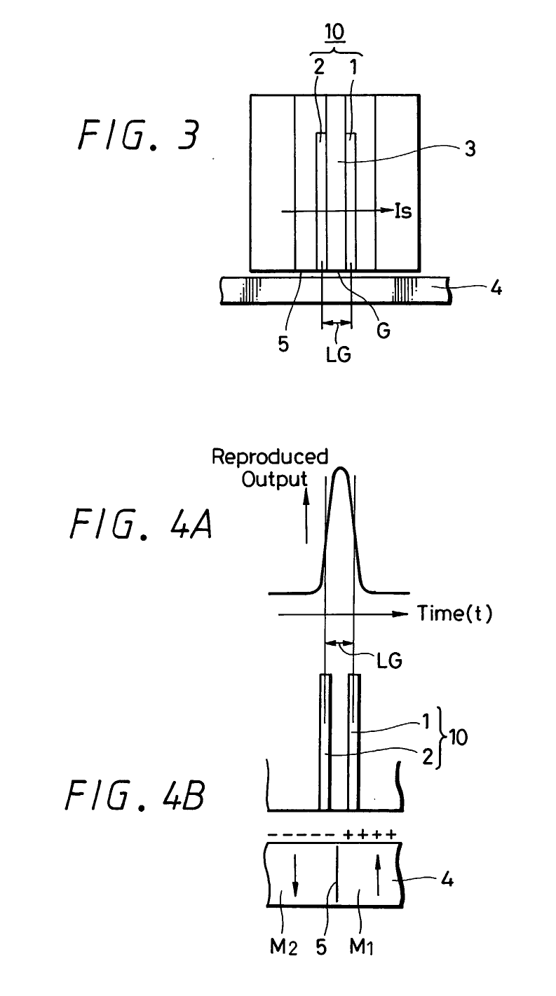

FIG. 3 is a schematic cross-sectional view showing a fundamental configuration of a magnetic sensor using magneto-resistive effect (MR magnetic sensor) 10 according to the present invention. As shown in FIG. 3, this MR magnetic sensor 10 has a configuration in which first and second magneto-resistive effect elements (MR elements) 1 and 2 having conductive multilayer structures are laminated through a nonmagnetic intermediate gap layer 3 made of a conductive material, in this embodiment. Front ends of the respective elements 1 and 2 are opposed to a front surface 5 at which they are brought in contact with or opposed to a magnetic signal detected material 4, e.g., magnetic scale or a magnetic recording medium such as a hard disk, e.g., ABS surface.

In this embodiment, the magnetic sensor using magneto-resistive effect 10 has a CPP configuration in which a sense current Is flows in the direction perpendicular to the layer planes of the first and second MR elements 1 and 2.

FIG. 4B shows the manner in which a signal is reproduced from the magnetic signal detected material 4 by the MR magnetic sensor 10 having the above-mentioned configuration. FIG. 4A shows a reproduced output characteristic obtained at that time. Specifically, in this case, when the MR magnetic sensor 10 moves across recorded signal magnetic domains (recorded bits) M1 and M2 which are perpendicularly magnetized in the thickness direction of the detected material 4 as arrows in FIG. 4B schematically illustrate magnetized states, the MR magnetic sensor 10 produces the reproduced output shown in FIG. 4A, i.e., detected output.

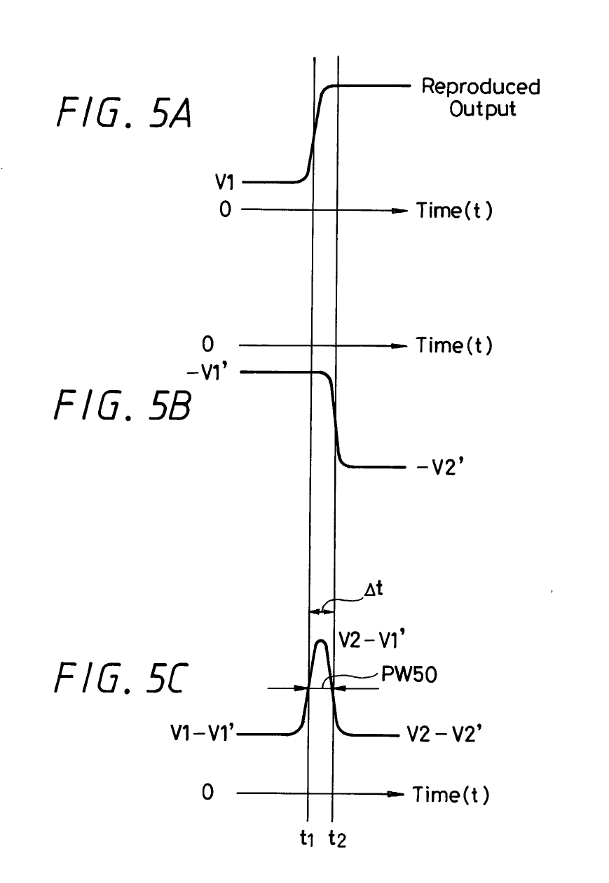

The above-mentioned operations will be described with reference to FIGS. 5A to 5C. When the first and second MR elements 1 and 2 pass a magnetic wall 5 between the adjacent recorded signal magnetic domains M1 and M2, which are magnetized in the opposite directions, of the detected material 4, the first and second MR elements 1 and 2 generate output characteristic curves in which reproduced output voltages are rapidly changed with a difference between the pitches in which the two MR elements 1 and 2 are located, specifically, a difference Δt between times t₁ and t₂ determined by a distance between central surfaces with respect to the respective thickness directions of the magnetization free layers which serve as magnetic flux sensing films of the respective MR elements 1 and 2 and the transport speeds of the two MR elements 1 and 2.

In the present invention, the first and second MR elements 1 and 2 has magneto-resistive change characteristics of opposite polarities in such a manner that the reproduced output of the first and second MR elements 1 and 2 may be generated as a differential output. When the first MR element 1, for example, passes the magnetic wall 5 so that the first MR element 1 exhibits a characteristic in which a voltage +V1 is raised to a voltage +V2 as shown in FIG. 5A, the second MR element 2 passes the magnetic wall 5 so that the second MR element 2 exhibits a characteristic in which a voltage −V′ is changed to a voltage −V2′ as shown in FIG. 5B. Thus, an isolated waveform output is obtained as an output of the magnetic sensor 10 as shown in FIG. 5C.

Since a half width PW50 of the isolated waveform output shown in FIG. 5C corresponds to a distance between the two central surfaces of the magnetic flux sensing films of the first and second MR elements 1 and 2, a magnetic gap length LG of a magnetic gap G which decides a resolution is set by the distance between the central surfaces.

Conversely, according to the MR magnetic sensor 10 having the first and second MR elements 1 and 2, since the difference Δt (=t₁−t₂) can be converted into a distance by the half width PW50 of the isolated waveform output shown in FIG. 5C and a relative linear velocity between the MR magnetic sensor 10 and the detected material 4, the MR magnetic sensor 10 according to the present invention can be applied to a magnetic scale.

As described above, the MR magnetic sensor 10 has the configuration in which the first and second MR elements 1 and 2 are laminated through the nonmagnetic conductive intermediate gap layer 3, the first and second MR elements 1 and 2 should preferably have their magneto-resistive change characteristics which are opposite to each other in polarity.

Then, the first and second MR elements 1 and 2 have SV type GMR configurations including respectively antiferromagnetic layers, magnetization fixed layers and magnetization free layers serving as magnetic flux sensing films or ferromagnetic tunnel magneto-resistive effect element (TMR element) configurations, and the first and second MR elements 1 and 2 are laminated through the nonmagnetic intermediate gap layer 3. In this case, the MR magnetic sensor 10 has the CPP configuration in which a sense current flows in the lamination layer direction, i.e., in the direction perpendicular to the layer plane.

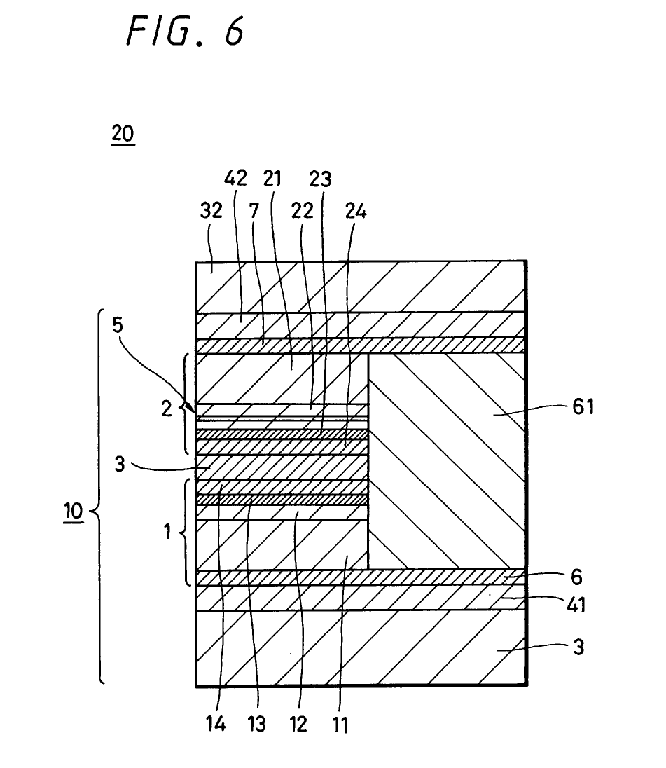

FIG. 6 is a schematic cross-sectional view showing examples of this MR magnetic sensor 10 and the MR magnetic head 20 including this MR magnetic sensor 10 as a magnetic sensing portion, for example. As shown in FIG. 6, on a first magnetic shield and electrode 31, there is formed a first MR element 1 of a bottom type through a conductive first nonmagnetic gap layer 41 and an underlayer 6. on this first MR element 1, there is formed the MR magnetic sensor 10 having a second MR element 2 of a top type formed through a nonmagnetic intermediate gap layer 3.

On the surface of the second MR element 2, there is formed a protective layer 7 on which there is formed a second magnetic shield cum electrode 32 through a conductive second nonmagnetic gap layer 42.

The front end of this MR magnetic sensor 10 faces a front surface 5 which is brought in contact with or opposed to a magnetic signal detected material, e.g., magnetic recording medium (not shown) and an insulating layer 61 is embedded into the rear portion of the MR magnetic sensor 10 and the like. A flux guide, which will be described later on, is disposed at this rear portion of the MR magnetic sensor 10.

The first MR element 1 of the bottom type is comprised in such a fashion that a first antiferromagnetic layer 11, a first magnetization fixed layer 2 which is ferromagnetically exchange-coupled to the first antiferromagnetic layer 11, a conductive first nonmagnetic spacer layer 13 and a first magnetization free layer 14 are deposited on the underlayer 6, which is formed according to the need; in that order.

The second MR element 2 of the top type is comprised in such a fashion that a second magnetization free layer 24, a conductive second nonmagnetic spacer layer 23, a second magnetization fixed layer 22 and a second antiferromagnetic layer 21, which is ferromagnetically exchange-coupled to this magnetization fixed layer 22, are laminated on the first MR element 1 through the nonmagnetic intermediate gap layer 3, in that order.

The magnetization fixed layer 12 or 22 of any one of the first and second MR elements 1 and 2 is comprised of a single layer or ferromagnetic layers of an odd number of layers based upon a so-called lamination layer ferrimagnetic layer structure in which directions of magnetic moments are coupled to each other in an anti-parallel fashion. The magnetization fixed layer 22 or 12 of the other MR element 2 or 1 has a lamination layer structure of ferromagnetic layers of an even number of layers based upon a lamination layer ferrimagnetic layer structure in which directions of magnetic moments are coupled to each other in an anti-parallel fashion.

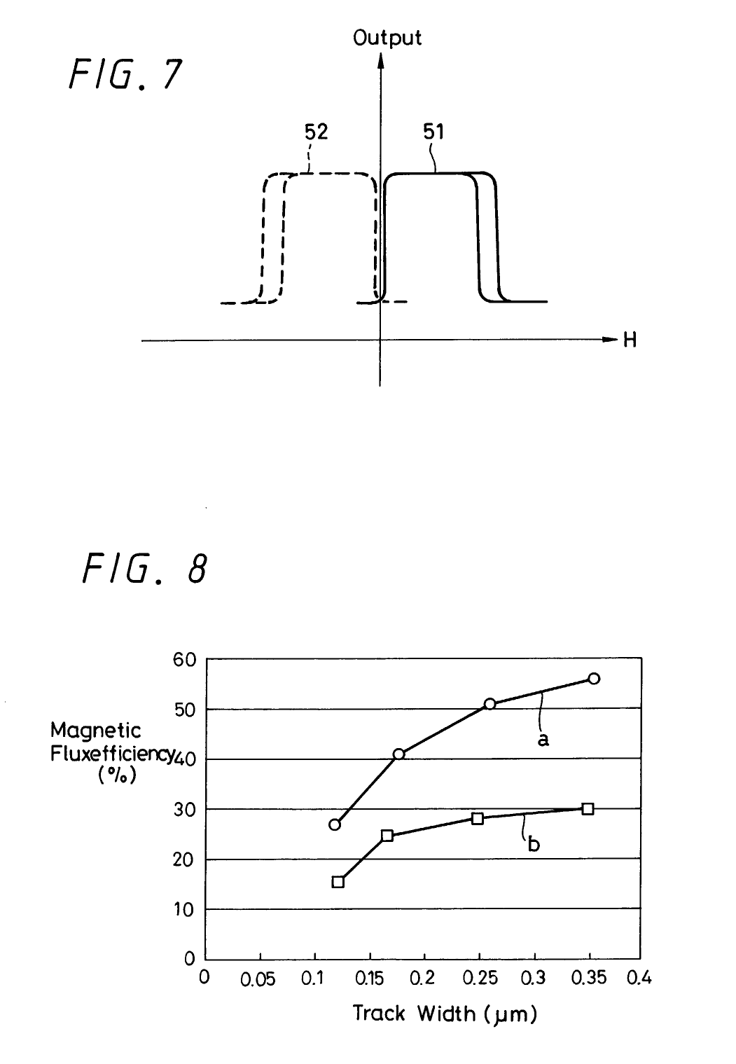

At that time, the two MR elements 1 and 2 can be formed as MR elements having magneto-resistive change characteristics in which the antiferromagnetic layers 11 and 21 and the first and second magnetization fixed layers 12 and 22, which are ferromagnetically exchange-coupled to the antiferromagnetic layers 11 and 21, are magnetized in the same direction and are opposite in polarity as shown by curves 51 and 51 in FIG. 7.

Alternatively, both of the magnetization fixed layers 12 and 22 of the first and second MR elements 1 and 2 may have the lamination layer structure based upon the single layer structure of ferromagnetic layer or a plurality of ferromagnetic layer structures of an odd number of layers in which directions of magnetic moments are coupled to each other in an anti-parallel fashion or ferromagnetic layer structures of an even number of layers in which directions of magnetic moments are coupled to each other in an anti-parallel fashion such that the antiferromagnetic layers 11 and 21 may be magnetized in an anti-parallel fashion.

In order that the magnetized states of the same direction which is perpendicular to a detection magnetic field may be obtained with stability under the condition that the detection magnetic field is not applied to the magnetization free layers 14 and 24 from the outside (this state will hereinafter be referred to as a “non-magnetic field state”), although not shown in FIG. 6, stabilizing bias hard magnetic layers which are magnetically coupled to the end portions of the magnetization free layers of the first and second magneto-resistive effect elements 1 and 2 are disposed on both sides of the portions in which at least the magnetization free layers 14 and 24 are disposed. Alternatively, this stabilizing bias hard magnetic layer may be removed or there may be provided an antiferromagnetic layer based upon a long-distance exchange-couple comprised of the stabilizing bias hard magnetic layer and the nonmagnetic intermediate gap layer 3.

As described above, since the magnetic sensor using magneto-resistive effect according to the present invention generates the differential output, in this case, the magnetic head using magneto-resistive effect, for example, of the magnetic signal detection material can increase a durability against a thermal asperity generated when the magnetic head using magneto-resistive effect and the magnetic recording medium contact with each other. Specifically, a general shield type magnetic head encounters a problem in which a base line of its output waveform is shifted and becomes irregular by a thermal asperity or the general shield type magnetic head unavoidably detects an abnormal peak which is not caused by a signal magnetic field from a medium. According to the present invention, these problems can be avoided.

In addition, according to the present invention, in a detection resolution of a magnetization transition of recording bits, a magnetic gap length can be decided based upon the thickness of the nonmagnetic intermediate gap layer disposed between the two magneto-resistive effect elements. In this case, there can be formed a sufficiently narrow magnetic gap so that a detection resolution can be increased sufficiently. As a consequence, a magnetic recording medium can be made extremely high in density.

Characteristic curves a and b in FIG. 8 show measured results of relationships between respective magnetic flux efficiencies (%) and respective track widths of the magnetic shield type magnetic head using magneto-resistive effect having the above-mentioned differential configuration according to the present invention and a magnetic shield type magnetic head using magneto-resistive effect having a related-art structure.

Also in the related-art shield type magnetic head using magneto-resistive effect and also in the present invention, the magnetic flux efficiency is lowered as the track width is reduced.

However, a study of FIG. 8 reveals that the magnetic head according to the present invention can obtain a magnetic flux efficiency approximately twice as high as that of the related-art magnetic shield type magnetic head, thereby resulting in a head output being increased greatly.

That is, while the magnetic flux is being maintained, the recording track width can be reduced considerably as compared with the related art and hence it is possible to realize super-high density perpendicular recording higher than 100 Gbpsi.

In the above-mentioned configuration, while the first and second MR elements 1 and 2 may have the configurations having characteristics which are opposite to each other in polarity, the present invention is not limited thereto and the first and second MR elements 1 and 2 may have the configurations having magneto-resistive change characteristics of the same polarity so that the detected output from the first and second MR elements 1 and 2 can be generated as a differential output from a circuit standpoint.

In the above-mentioned configuration, the magnetic shield and electrodes 31 and 32 can be comprised of NiFe plated layers formed on an AlTiC substrate, for example.

The underlayer 6 is provided in order to decrease influences such as contamination from the deposited surface of the MR element and is also provided in order to improve crystal orientation of a film deposited on the underlayer 6. This underlayer 6 can be made of Ta, for example, and other suitable materials such as Zr, Ru, Cr and Cu. Moreover, the underlayer 6 can be made up of a lamination layer structure in which other material layers are laminated on these material layers.

The antiferromagnetic layers 11 and 12 can be made up of PtMn, NiMn, PdPtMn, Ir—Mn, Rh—Mn, Fe—Mn, Ni oxide, Co oxide, Fe oxide and the like.

When the blocking temperatures of these ferromagnetic layers 11 and 21 are made different from each other as mentioned before, compositions of the ferromagnetic layers 11 and 21 may be changed or the thicknesses of the ferromagnetic layers 11 and 21 may be changed.

The ferromagnetic layers comprising the magnetization fixed layers 12 and 22 may be made up of ferromagnetic layers of Co, Fe, Ni or alloy of two or more of these materials or materials of a combination of different compositions, e.g., respective ferromagnetic layers of Fe and Cr. Moreover, the ferromagnetic layers comprising the magnetization fixed layers 12 and 22 can be made up of the aforementioned materials to which additives B, C, N, O, Zr, Hf, Al, Ta and the like may be added.

As materials of nonmagnetic interposed layers interposed between the respective ferromagnetic layers required when these magnetization fixed layers 12 and 22 have the lamination ferrimagnetic layer structure based upon the lamination layer of a plurality of ferromagnetic layers in which magnetic moment directions are coupled to each other in an anti-parallel fashion, there can be used such thin materials as Ru, Cr, Rh and Ir having a thickness of 0.9 nm, for example.

When the magnetization free layers 14 and 24 are made of a CoFe film, an NiFe film, a CoFeB film or a lamination layer film of these films, e.g., CoFe/NiFe or CoFe/NiFe/CoFe, there can be realized a larger MR ratio and a soft magnetic characteristic.

The conductive nonmagnetic intermediate gap layer 3, the first and second nonmagnetic gap layers 41, 42, the first and second nonmagnetic spacer layers 13 and 23 and the like may be made up of Ta, Cu, Au, Ag, Pt, Al or Cu—Ni and Cu—Ag.

Since the thickness of the nonmagnetic intermediate gap layer 3 prescribes the magnetic gap length LG of the substantial magnetic gap G in the configuration shown in FIG. 3, this thickness of the nonmagnetic intermediate gap layer 3 is determined based upon a recording density at which a signal is read out from the magnetic recording medium.

Moreover, in the configuration in which the first and second magnetization free layers 14 and 24 are disposed across this nonmagnetic intermediate gap layer 3, with respect to the relationship between the film thicknesses of these magnetization free layers 14 and 24, in order to maintain a detection resolution relative to a detection magnetic field of recording bits or the like and also in order to smoothly capture magnetic flux, the film thicknesses of the two magnetization free layers 14 and 24 should preferably be made thinner than that of the nonmagnetic intermediate gap layer.

When this nonmagnetic intermediate gap layer 3 prescribes the magnetic gap length LG, the thickness of the nonmagnetic intermediate gap layer 3 can be selected in a range of from 1 nm to 50 nm and should preferably be selected in a range of from 1 nm to 20 nm. When the thickness of the nonmagnetic intermediate gap layer 3 is less than 1 nm, an exchange-coupling or a magnetostatic-coupling occurs between the first and second magnetization free layers 14 and 24 so that sensitivity is lowered unavoidably. Moreover, when the thickness of the nonmagnetic intermediate gap layer 3 exceeds 50 nm, it becomes difficult to form a magnetic circuit between the two magnetization free layers 14 and 24.

The stabilizing bias hard magnetic layer can be made up of CoCrPt or Coγ-Fe₂O₃ and the like.

The protective layer 24 can be made up of Ta, W, Zr and the like, for example.

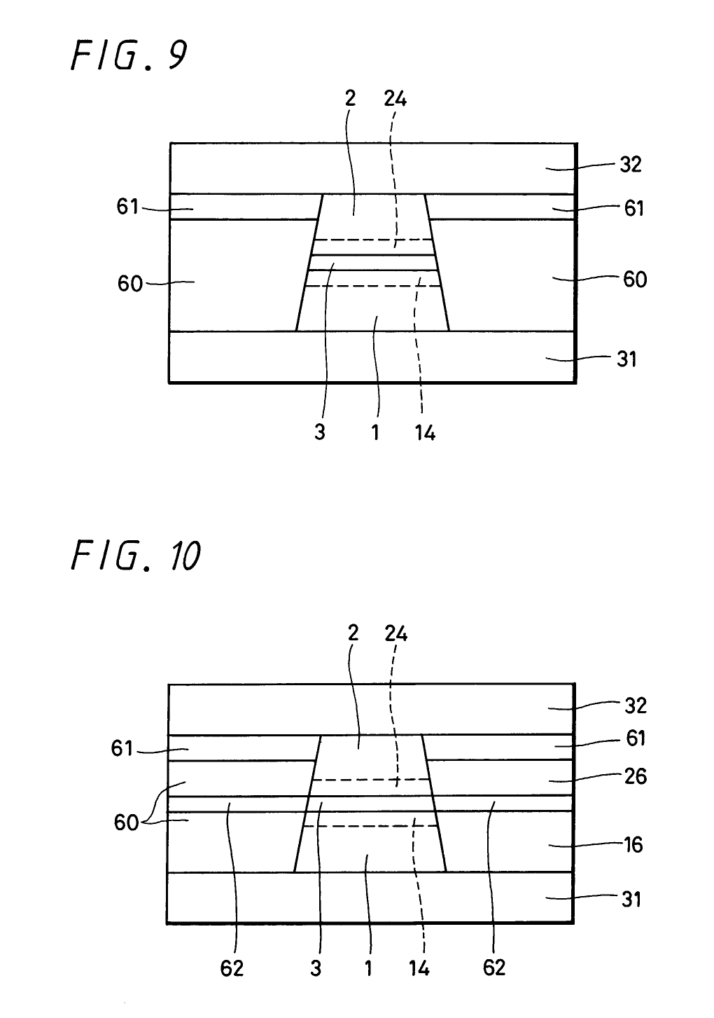

In the above-mentioned configuration, the lamination layer structure portion of the first and second MR elements 1 and 2 may be given a predetermined track width by pattern etching. FIG. 9 is a schematic front view showing the lamination layer structure portion from the front side. As shown in FIG. 9, in general, the above-mentioned lamination layer structure portion tends to be shaped like a trapezoid. Therefore, a bias magnetic field applied to the first and second magnetization free layers 14 and 24 of the two MR elements 1 and 2 from the stabilizing bias hard magnetic layer 60 disposed on both sides of the lamination layer structure portion become asymmetric with the result that a so-called base shift occurs in the output waveform, shown in FIG. 5C, generated from a differential output between the output of the first and second MR elements 1 and 2, thereby resulting in an output waveform being disordered.

In order to avoid such disadvantage, as shown in a schematic front view of FIG. 10, first and second stabilizing bias hard magnetic layers 16 and 26 whose stabilizing bias magnetic fields were controlled based upon factors such as compositions and thicknesses may be laminated on the first and second magnetization free layers 14 and 24 through a nonmagnetic intermediate layer 62, for example.

This nonmagnetic intermediate layer 62 may be made up of an insulating layer which can block shunting of a sense current which flows through the stabilizing bias hard magnetic layers 16 and 26.

In FIGS. 9 and 10, elements and parts identical to those of FIG. 6 are denoted by identical reference numerals and therefore need not be described in detail.

While the lamination structure portion of the first and second MR elements 1 and 2 is formed by pattern etching in the example shown in FIGS. 6, 9 and 10, the present invention is not limited thereto, and such a variant is also possible. That is, as shown in schematic front views of FIGS. 14 and 24, for example, any one of the first and second MR elements may be formed by patterning and the other element may be formed on the whole surface, for example.

In this case, the stabilizing bias magnetic field may be applied respectively to the magnetization free layers 14 and 24 of the first and second MR elements 1 and 2. Specifically, the stabilizing bias magnetic field may be applied to the MR element, formed by patterning, from the first or second stabilizing bias hard magnetic layer 16 or 26, for example, and the stabilizing bias magnetic field may be applied to the other MR element, which is not formed by patterning, by exchange-coupling the bias layer 63 formed of the antiferromagnetic layer, for example, to the magnetization free layer.

In this manner, the stabilizing bias magnetic fields applied to the first and second magnetization free layers 14 and 24 with the different patterns can be varied and hence the problem of the above-mentioned base shift can be solved.

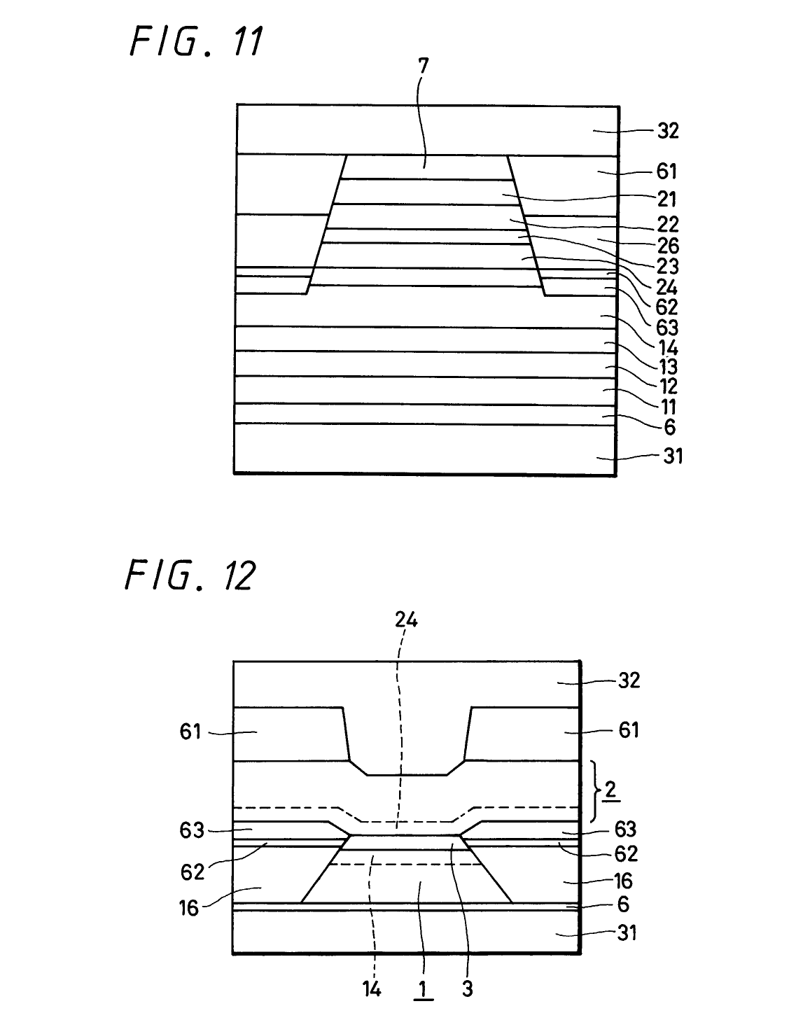

Also in FIGS. 11 and 12, elements and parts identical to those of FIGS. 6, 9 and 10 are denoted by identical reference numerals and therefore need not be described in detail.

As described above, since the magnetic sensor using magneto-resistive effect includes the hard magnetic layers or the antiferromagnetic layers which individually apply the stabilizing bias magnetic fields to the first and second magnetization free layers 14 and 24, the stabilizing bias magnetic fields can be properly applied to the respective MR elements under control. Therefore, symmetry of the operations of the first and second MR elements can be obtained, and therefore the base shift of the output waveform can be removed.

When the first and second magnetization free layers 14 and 24 of the first MR elements 1 and 2 are different from each other in width as shown in FIG. 9, for example, saturated magnetization can be made different from each other by selecting the compositions of these magnetization free layers 14 and 24, e.g., the lamination layer structure of CoFe and NiFe and the single layer structure of CoFe and/or a magnetization volume, given by a product of these saturated magnetization and film thicknesses, can be adjusted by selecting the film thicknesses of the magnetization free layers 14 and 24. Specifically, the thickness or the saturated magnetization of the narrow second magnetization free layer 24 shown in FIG. 9, for example, can be made larger than that of the first magnetization free layer 14. In this manner, the symmetry of the operations of the two MR elements 1 and 2 can be obtained.

When a magnetic head assembly and a magnetic head in a general HDD apparatus is flown from a magnetic recording medium to perform reproducing operations, it is considered that flying amounts of the first and second magnetization free layers 14 and 24 in the first and second MR elements 1 and 2 from the magnetic recording medium may become different from each other substantially. Also in this case, symmetry of operations can be compensated by properly selecting the thicknesses of the first and second magnetization free layers 14 and 24, for example.

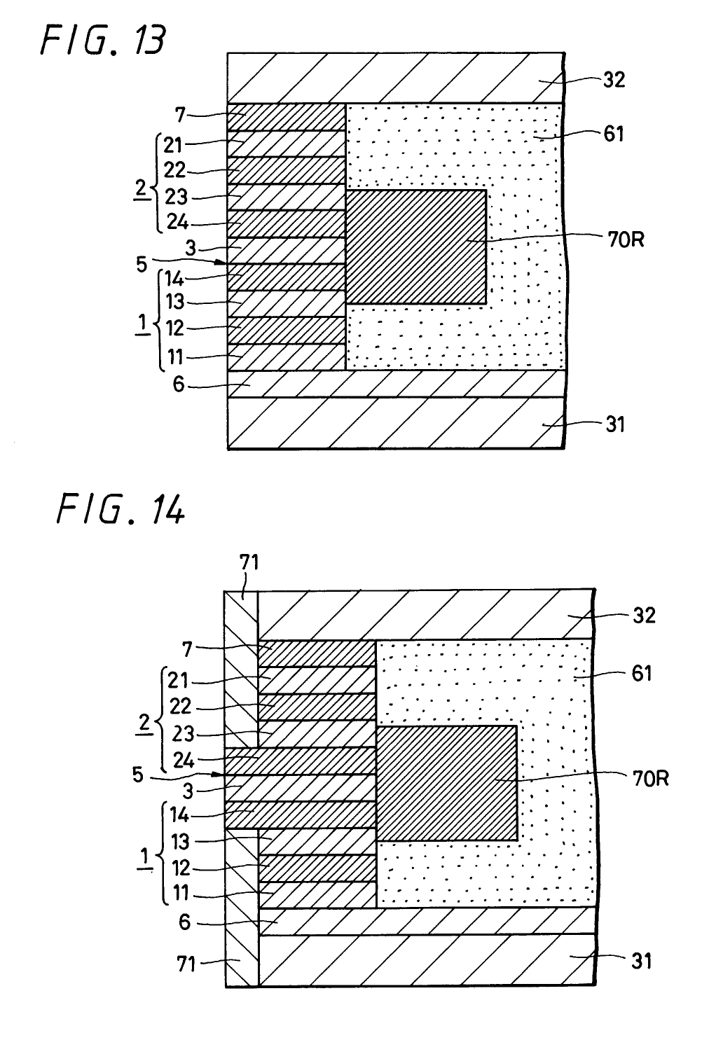

FIG. 13 is a schematic cross-sectional view of another embodiment of the present invention. In this embodiment, a flux guide layer 70R is disposed in the rear portions of the first and second MR elements 1 and 2 and a closed magnetic path (magnetic circuit) is comprised of the first and second magnetization free layers 14 and 24, whereby a leakage of detection signal magnetic fields can be decreased, i.e., detection signal magnetic fields can be concentrated and hence a magnetic flux efficiency can be improved more.

This rear flux guide layer 70R can be made up of a ferromagnetic material having a soft magnetic characteristic such as NiFe and amorphous CoZrNb. This flux guide layer 70R should preferably have a magnetic permeability higher than 50 from a standpoint of improving a magnetic flux efficiency. Moreover, in order to avoid the shunting of the sense current, the flux guide layer 70R should preferably be made of high-resistance material. To this end, this flux guide layer 70R can be made of a granular film with an insulating material or a lamination layer film with an insulating layer, for example.

In FIG. 13, elements and parts identical to those of FIGS. 6, 9 and 10 are denoted by identical reference numerals and therefore need not be described in detail.

FIG. 14 is a schematic cross-sectional view showing another example of a magnetic sensor using magneto-resistive effect, for example. As shown in FIG. 14, only the lamination layer portion of the first and second magnetization free layers 14 and 24 of the first and second MR elements 1 and 2 and the nonmagnetic intermediate gap layer 3 interposed between the first and second magnetization free layers 14 and 24 may be brought in contact with or face the opposing surface to the magnetic signal detected material, e.g., magnetic recording medium, i.e., the front surface 5 and other front ends are retreated from the front surface 5. This retreated surface may be covered with a mask layer 71 formed of a nonmagnetic insulating layer.

With the above-mentioned configuration, most of the first and second MR elements can be avoided from being directly brought in contact with the magnetic recording medium. As a consequence, it is possible to avoid the so-called thermal asperity which influences the characteristics of the respective MR elements due to friction heat produced when the first and second MR elements are brought in contact with the magnetic recording medium. Thus, there can be made up a stable MR magnetic sensor or MR magnetic head which is excellent in heat-resistant property.

Also in FIG. 14, elements and parts identical to those of FIG. 13, for example, are denoted by identical reference numerals and therefore need not be described in detail.

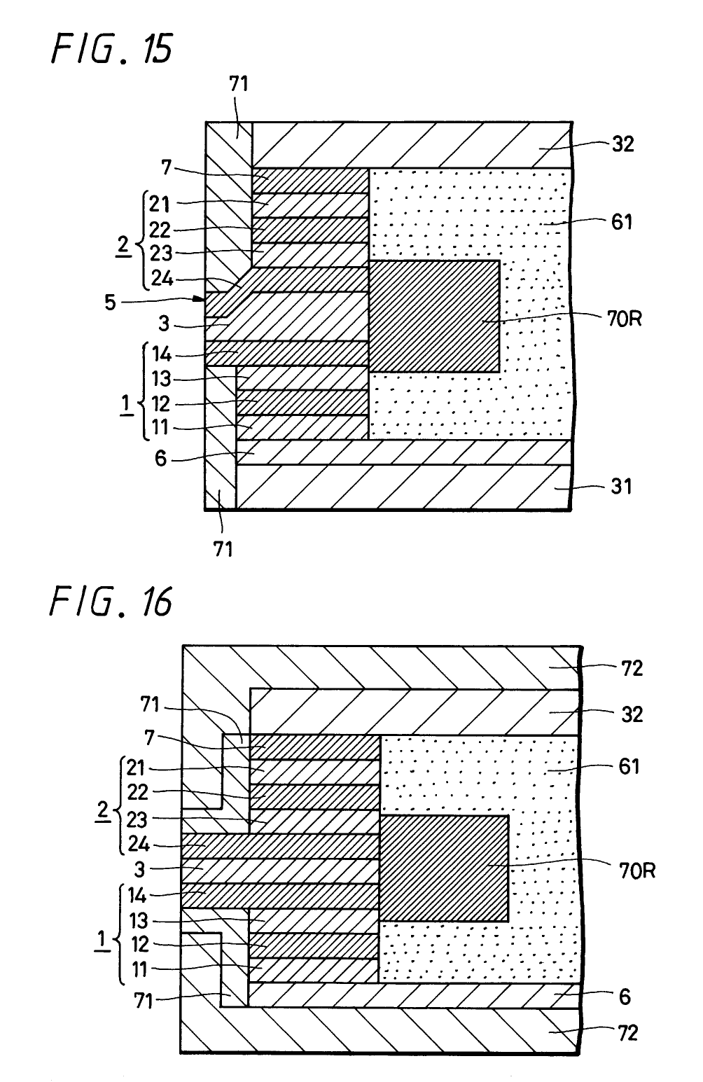

FIG. 15 is a schematic cross-sectional view showing a further example of a magnetic sensor using magneto-resistive effect according to the present invention. In this case, the thickness of the nonmagnetic intermediate gap layer 3 is reduced in the front surface 5 and is increased in the rearward.

According to the above-mentioned configuration, the magnetic gap length LG of the magnetic gap G prescribed by the thickness of the nonmagnetic intermediate gap layer 3 in the front surface 5 can be reduced in width more, whereby a recording density can be increased more.

Then, in this case, since the thickness of the nonmagnetic intermediate gap layer 3 is reduced in the front and is sufficiently increased in the rearward, a magnetic coupling between the first and second magnetization free layers 14 and 24 can be avoided, and hence it is possible to avoid the symmetry of operations from being hindered by this magnetic coupling.

Also in FIG. 15, elements and parts identical to those of FIGS. 13 and 14 are marked by identical reference numerals and therefore need not be described in detail.

Further, FIG. 16 is a schematic cross-sectional view showing a further example of a magnetic sensor using magneto-resistive effect according to the present invention. In this case, in the configuration in which the first and second magnetization free layers 14 and 24 and the nonmagnetic intermediate gap layer 3 interposed between the first and second magnetization free layers 14 and 24 are made to face the front surface and other portions are retreated from the front surface, a mask layer 71 formed of an insulating layer can be formed and a magnetic shield 72 can be disposed on the surface of the mask layer 71.

As described above, the magnetic shield layer 72 is disposed on the front surface, whereby the half-width PW50 can be reduced as shown in FIG. 5C.

As the material of this magnetic shield layer 72, there can be used NiFe (permalloy), for example. Moreover, the insulating layer of the mask layer 71 can be made of A1₂O₃, SiO₂ and the like.

Then, in this configuration, although not shown, it is desirable that an electrical breakdown should be avoided by interposing an insulating layer such as Al₂O₃ between the magnetic shield layer 72 and the electrodes 31 and 32.

In FIG. 16, elements and parts identical to those of FIGS. 13, 14 and 15 are denoted by identical reference numerals and therefore need not be described in detail.

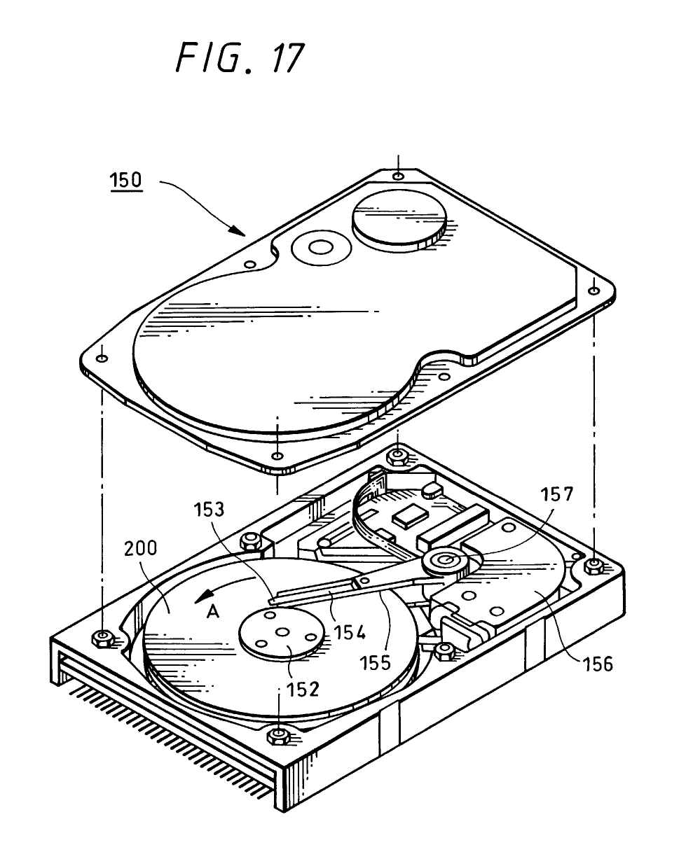

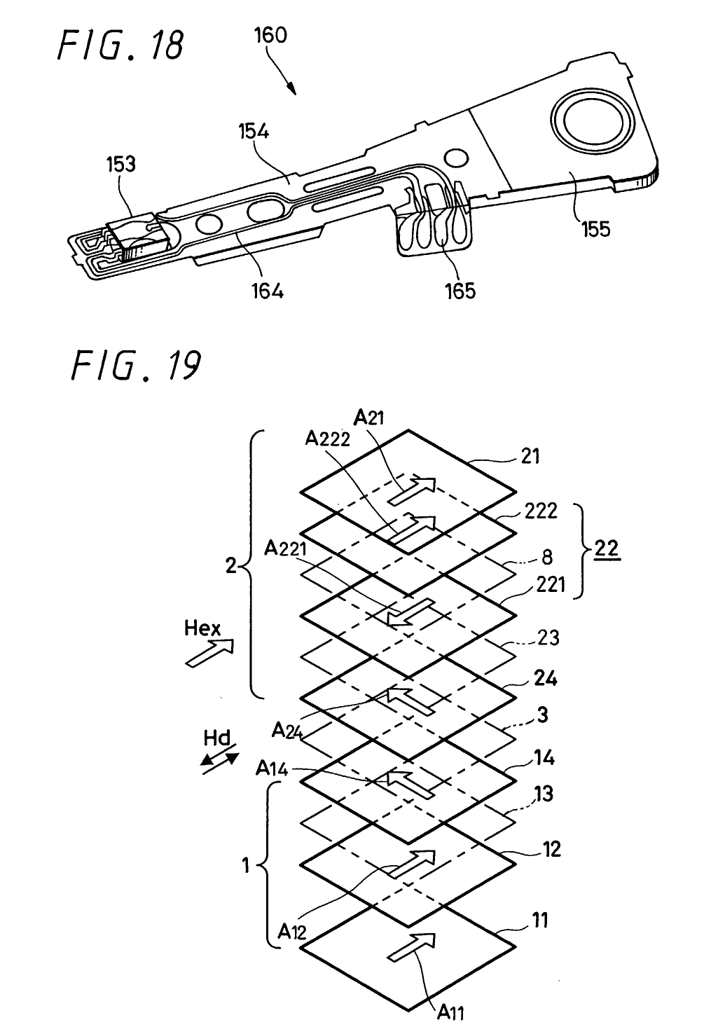

Next, an example of a magnetic recording and reproducing apparatus to which a magnetic reproducing apparatus according to the present invention is applied will be described with reference to FIGS. 17 and 18.

This magnetic recording and reproducing apparatus, generally depicted by reference numeral 150 in FIG. 17, is an apparatus of the type using a rotary actuator. As illustrated, a perpendicular magnetic recording medium, in this example, a perpendicular recording disk 200 is held on a spindle 152 and rotated by a motor (not shown) which is driven in response to a control signal supplied from a control unit of a drive apparatus, not shown.

This magnetic recording and reproducing apparatus 150 may have the configuration to accommodate therein a plurality of disks 200.

A head slider 153 for recording and reproducing information stored in the disk 200 is attached to the tip end of a thin film-like suspension 154.

The head slider 153 has at its tip end mounted a magnetic head using magneto-resistive effect according to the present invention.

When the medium disk 200 is rotated, a medium opposing surface of the head slider 153, i.e., ABS plane may be held upwardly with a predetermined spacing amount from the surface of the disk 200. Alternatively, the magnetic head using magneto-resistive effect according to the present invention can be formed as a so-called contact transport type in which the slider 153 is brought in contact with the disk 200.

As shown in FIG. 17, the suspension 154 is connected to one end of an actuator arm 155 including a bobbin portion which holds a drive coil (not shown) and the like. A voice coil motor 156 which is one kind of linear motor is provided at the other end of the actuator arm 155. The voice coil motor 156 is comprised of a drive coil (not shown) wound around the bobbin portion of the actuator arm 155 and a magnetic circuit comprised of permanent magnets and opposing yokes opposed so as to sandwich this drive coil.

The actuator arm 155 is held by ball bearings (not shown) provided at two places in the upper and lower portions of the spindle 157 and can be rotated by the voice coil motor 156 so as to become freely slidable.

FIG. 18 is a perspective view showing a magnetic head assembly located in front of the actuator arm 155 seen from the disk side in an enlarged-scale. Specifically, as shown in FIG. 18, a magnetic head assembly 160 includes the actuator arm 155 having a bobbin portion for holding a drive coil, for example. The suspension 154 is connected to one end of the actuator arm 155.

The head slider 153 including the magnetic head using magneto-resistive effect according to the present invention is attached to the tip end of the suspension 154.

The suspension 154 includes a lead wire 164 for use in writing and reading a signal, and this lead wire 164 is electrically connected to respective electrodes of a magnetic head assembled in the head slider 153. Then, there is disposed an electrode pad 165 for the magnetic head assembly 160.

Since the magnetic reproducing apparatus including the magnetic head using magneto-resistive effect according to the present invention has the differential configuration, this magnetic reproducing apparatus is able to reliably read out recorded bits from the disk 200 which has been recorded at a recording density remarkably higher than that of the related art.

Next, the MR magnetic sensor 10 according to the present invention or embodiments of an MR magnetic sensor which serves as a magnetic sensing portion of an MR magnetic head will further be illustrated and will be described in detail. However, it is needless to say that the present invention is not limited to those embodiments and embodiments which will follow.

[First Embodiment]

In this embodiment, as shown in a schematic exploded perspective view of FIG. 19, since the MR magnetic sensor has the configuration in which the first MR element 1 of the so-called bottom type in which the antiferromagnetic layer is disposed at the bottom side and the second MR element 2 of the so-called top side in which the antiferromagnetic layer is disposed at the top side are laminated through the nonmagnetic intermediate gap layer 3, the first and second magnetization free layers 14 and 24 are laminated such that they are located close to each other. Then, the MR magnetic sensor according to this embodiment has the current perpendicular to plane configuration in which the sense current flows through the lamination layer direction.

Then, in this configuration, the first MR element 1 has an SV type GMR configuration of a bottom type (hereinafter referred to as a “BSV”) in which the first magnetization fixed layer 12 is comprised of a single layer, i.e., ferromagnetic layer of an odd number. The second MR element 2 has an SV type GMR configuration of a top type based upon a lamination layer ferrimagnetic layer structure, i.e., so-called synthetic configuration (hereinafter referred to as a “SSV”) in which the magnetization fixed layer 22 is comprised of ferromagnetic layers of an even number of layers, in this embodiment, first and second ferromagnetic layers 221 and 222 having the two-layer configuration having a ferromagnetism which are laminated through the nonmagnetic interposed layer 8 in such a manner that the directions of the magnetic moments are coupled to each other in an anti-parallel fashion.

The magnetization directions of the two magnetization free layers 14 and 24 are set to the same direction as shown by open arrows A14 and A24 in FIG. 19. At the same time, under the non-magnetic field condition, i.e., under the condition in which an external detection magnetic field Hd such as a detected signal magnetic field is not applied to the MR magnetic sensor, the magnetization directions of the two magnetization free layers 14 and 24 are set to the direction perpendicular to a detection magnetic field Hd directions The magnetization directions of the magnetization free layers 14 and 24 are set based upon the layout of the stabilizing bias hard magnetic layer or the long-distance exchange-couple film as will be described later on although not shown.

On the other hand, the magnetization directions of the first and second antiferromagnetic layers 11 and 21, the magnetization fixed layer 22 which are ferromagnetically exchange-coupled to the first and second antiferromagnetic layers 11 and 21 and the ferromagnetic layer 222 are set to the same directions as shown by open arrows A11, A12, A21, A222 and are also set to the same directions which are perpendicular to the magnetization directions, shown by open arrows A14 and A24, of the above-mentioned magnetization free layers 14 and 24.

At that time, since the magnetization fixed layer 22 of one MR element 2 has the synthetic configuration, in the ferromagnetic layer 221 on the side opposing the magnetization free layer 24, its magnetization direction (shown by an open arrow A221) can be set to the direction opposite to the magnetization direction (shown by the open arrow A12) of the magnetization fixed layer 12 opposing to the other magnetization free layer 14.

Specifically, the magneto-resistive characteristics of the first and second MR elements 1 and 2 can be made opposite to each other.

In FIG. 19, elements and parts identical to those of FIG. 6 are denoted by identical reference numerals and therefore need not be described in detail.

[Second Embodiment]

While the first MR element 1 has the BSV configuration and the second MR element 2 has the TSSV configuration in which the magnetization fixed layer has the lamination layer ferrimagnetic layer structure in the above-mentioned first embodiment, according to this embodiment, the first MR element 1 is formed as the SV type GMR of the bottom type (hereinafter referred to as a “BSSV”) in which the magnetization fixed layer has the lamination layer ferrimagnetic layer structure having the ferrimagnetic layers of two layers, i.e., so-called synthetic configuration and the second MR element 2 has the SV type GMR of the top type (hereinafter referred to as a “TSV”) in which the magnetization fixed layer has the single layer structure.

Also in this embodiment, similarly to the above-mentioned first embodiment, the magnetization direction of the first and second antiferromagnetic layers 11 and 21 and those of the ferromagnetic layers of the magnetization fixed layers, which are ferromagnetically exchange-coupled to the first and second antiferromagnetic layers 11 and 21, may be set to the same directions which are perpendicular to the magnetization directions of the magnetization free layers 14 and 24. In the ferromagnetic layer on the side opposing to the magnetization free layer 14 of the magnetization fixed layer 12, its magnetization direction may be set to the direction opposite to that of the antiferromagnetic layer.

That is, the magneto-resistive characteristics of the first and second MR elements 1 and 2 can be made opposite to each other.

[Third Embodiment]

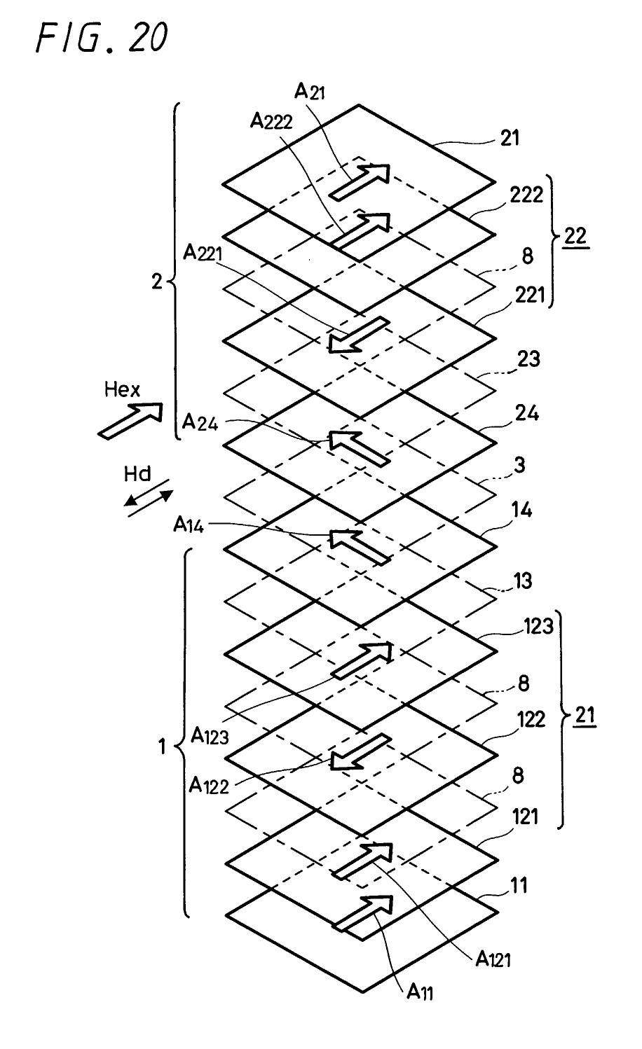

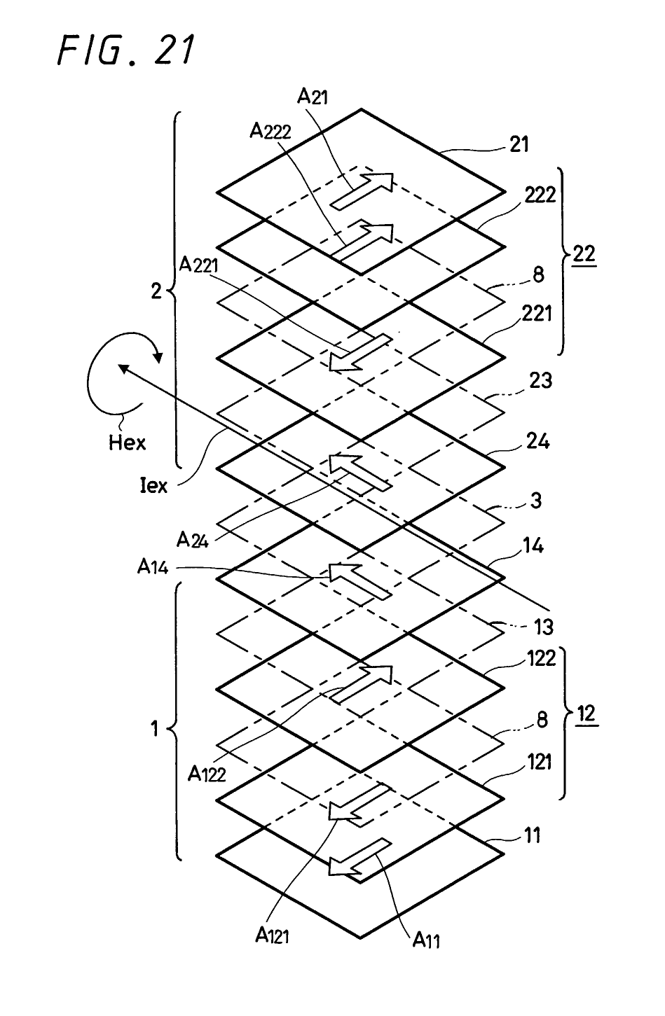

According to this embodiment, as shown in a schematic exploded perspective view of FIG. 20, in the configuration of the second MR element 2, the magnetization fixed layer 22 has the TSSV configuration comprised of an even number, or double-layer constituent ferromagnetic layers similarly to the first embodiment shown in FIG. 19. The magnetization fixed layer 12 of the first MR element 1 has the multilayer structure bottom type SV type GMR of the so-called double synthetic configuration (hereinafter referred to as a “BDSSV”) in which first to third constituent ferromagnetic layers 121 to 123, or an odd number of three layers are laminated through the nonmagnetic interposed layers 8 such that the directions of the magnetic moments are coupled to each other in an anti-parallel fashion. Also in this case, magnetization directions of the first and second antiferromagnetic layers 11 and 21 and magnetization directions of the respective constituent ferromagnetic layers 121 and 222 of the magnetization fixed layers 12 and 22 which are ferromagnetically exchange-coupled to the first and second antiferromagnetic layers 11 and 21 can be set to the same directions as shown by open arrows A11, A121, A222 and A21 so that the first and second MR elements 1 and 2 may have the magneto-resistive change characteristics which are opposite to each other in polarity.

In FIG. 20, elements and part identical to those of FIGS. 6 and 19 are denoted by identical reference numerals and therefore need not be described in detail.

[Fourth Embodiment]

In this embodiment, the first MR element 1 has the BSSV type configuration, and the magnetization fixed layer of the second MR element 2 has the so-called double synthetic configuration based upon an odd number, or three layers of the lamination layer ferrimagnetic layer structure so that the MR magnetic sensor may be formed as the SV type GMR of the top type (hereinafter referred to as a “TDSSV”). Also in this case, the magnetization directions of the antiferromagnetic layers 11 and 12 and the magnetization directions at the portions which are ferromagnetically exchange-coupled to the magnetization fixed layers are set to the same directions so that the first and second MR elements 1 and 2 may be formed as the MR elements having the magneto-resistive change characteristics which are opposite to each other in polarity.

[Fifth Embodiment]

In this embodiment, as shown in a schematic exploded perspective view of FIG. 21, the first and second MR elements 1 and 2 have the BSSV configuration and the TSSV configuration of the lamination ferrimagnetic layer structures based on an even number of layers in which the first magnetization fixed layers 12 and 22 of the first and second MR elements 1 and 2 include the double-layer ferromagnetic layers 121, 122 and 221, 222. The magnetization directions of these respective layers are shown by open arrows A121 and A122, A221 and A222. In this case, the magnetization direction of the first antiferromagnetic layer 11 and the magnetization direction of the constituent ferromagnetic layer 121 of the first magnetization fixed layer which is ferromagnetically exchange-coupled to the first antiferromagnetic layer 11 and the magnetization direction of the second antiferromagnetic layer 21 and the magnetization direction of the constituent ferromagnetic layer 222 of the second magnetization fixed layer 22 which is ferromagnetically exchange-coupled to the second antiferromagnetic layer 21 are set to the directions opposite to each other, and the first and second MR elements 1 and 2 may have magneto-resistive change characteristics which are opposite to each other in polarity.

In FIG. 21, elements and parts identical to those of FIGS. 6, 19 and 20 are denoted by identical reference numerals and therefore need not be described in detail.

[Sixth Embodiment]

In this embodiment, the first MR element 1 has the BSV configuration, the second MR element 2 has the TSV configuration and the magnetization fixed layer is comprised of the single layer magnetic layer. Also in this case, the magnetization direction of the first antiferromagnetic layer 11, the magnetization direction of the first magnetization fixed layer which is ferromagnetically exchange-coupled to the first antiferromagnetic layer, the magnetization direction of the second antiferromagnetic layer 21 and the magnetization direction of the second magnetization fixed layer 22 which is ferromagnetically exchange-coupled to the second antiferromagnetic layer 21 are set to the directions opposite to each other, and the first and second MR elements 1 and 2 may have magneto-resistive change characteristics which are opposite to each other in polarity.

The following table 1 has enumerated the configurations of the first and second MR elements 1 and 2 in the above-mentioned first to sixth embodiments.

TABLE 1

| | First | Second | Third | Fourth | Fifth | Sixth |
|---|---|---|---|---|---|---|
| | embodiment | embodiment | embodiment | embodiment | embodiment | embodiment |
| Second MR | TSSV | TSV | RSSV | TDSSV | TSSV | TSV |
| element | | | | | | |
| First MR | BSV | BSSV | BDSSV | BSSV | BSSV | BSV |
| element | | | | | | |
| Polarities of | Opposite | opposite | opposite | opposite | opposite | opposite |
| first and second | polarity | polarity | characteristic | characteristic | characteristic | characteristic |
| MR elements | | | | | | |
| Magnetizations | same | same | same | same | opposite | opposite |
| directions of | direction | direction | direction | direction | direction | direction |
| exchange-coupled | | | | | | |
| portions of anti- | | | | | | |
| ferromagnetic layers | | | | | | |
| of first and second | | | | | | |
| MR elements | | | | | | |
| Normalized annealing | magnetic | magnetic | magnetic | magnetic | flowing | flowing |
| magnetization of | field of | field of | field of | field of | magnetic | magnetic |
| antiferromagnetic | same | same | same | same | field | field |
| layers | direction | direction | direction | direction | | |
| | applied | applied | applied | applied | | |

TSSV: top synthetic SV type GMR
TSV: top SV type GMR
TDSSV: top double synthetic SV type GMR
BSV: bottom SV type GMR
BSSV: bottom synthetic SV type GMR
BDSSV: bottom double synthetic SV type GMR

[Seventh Embodiment]

In this embodiment, the first and second MR elements 1 and 2 may have the magneto-resistive change characteristics which are the same in polarity. Specifically, in the first and second magnetization fixed layers 12 and 22, their ferromagnetic layers opposed to the first and second magnetization free layers 14 and 24 are magnetized in the same direction.

Then, in this case, the output from the two MR elements 1 and 2 may be generated as a differential output to the outside by a differential amplifier, for example.

Since it is desirable that the magnetization fixed layers of the respective MR elements 1 and 2 should have the lamination layer ferrimagnetic layer structures from a stability standpoint, similarly to the third to fifth embodiments, the magnetization fixed layers 12 and 22 of both of the first and second MR elements 1 and 2 should preferably have the lamination layer ferrimagnetic layer structures in which the ferromagnetic layers of not less than two layers are laminated such that the magnetic moment directions are coupled to each other in an anti-parallel fashion.

Next, the embodiments of the manufacturing methods according to the present invention will be described.

[First Embodiment of Manufacturing Method]

This embodiment is a method of manufacturing a MR magnetic sensor in which the magnetization directions of the antiferromagnetic layers 11 and 21 of the two MR elements 1 and 2 and those of the exchange-coupled portions of the magnetization fixed layers 12 and 22 are set to the same direction similarly to the above-mentioned first to fourth embodiments.

According to this embodiment, after the layers comprising the above-mentioned MR element 1, the nonmagnetic intermediate gap layer 3 and the layers comprising the second MR element 2 have been sequentially deposited and laminated, as shown in FIGS. 19 and 20, for example, an external magnetic field Hex of the same direction as the direction of the magnetization formed in the portion in which the antiferromagnetic layers 11 and 21 and the magnetization fixed layers 12 and 22 are exchange-coupled is applied to this lamination layer deposited film by a annealing process.

This applied external magnetic field Hex falls within a range of approximately 100 [Oe] to 10,000 [Oe], and annealing conditions are 260° C. and about 4 hours.

With the above-mentioned configuration, the portions in which the two antiferromagnetic layers 11 and 21 and the magnetization fixed layers 12 and 22 are exchange-coupled to each other are magnetized in the same direction simultaneously.

Therefore, according to this manufacturing method, regardless of the fact that the MR magnetic sensor includes the first and second MR elements 1 and 2, its manufacturing process can be simplified.

[Second Embodiment of Manufacturing Method]

According to this embodiment, there is provided a method of manufacturing an MR sensor in which the portions in which the antiferromagnetic layers 11 and 21 of the two MR elements 1 and 2 and the magnetization fixed layers 12 and 22 are exchange-coupled to each other are magnetized in the opposite directions similarly to the above-mentioned fifth and sixth embodiments.

Also in this embodiment, after the layers comprising the MR element 1, the nonmagnetic gap layer 3 and the layers comprising the second MR element 2 have been sequentially laminated and deposited, under annealing condition of approximately 260° C., as shown in FIG. 21, for example, an induced magnetic field Hex is generated by causing a DC current Iex to flow through the nonmagnetic intermediate gap layer 3 between the two MR elements 1 and 2 in the direction in which the external detection magnetic field is introduced. With this configuration, this induced magnetic field Hex is applied to the first and second antiferromagnetic layers 11 and 21 in the opposite directions so that the first and second antiferromagnetic layers 11 and 21 are magnetized in the opposite directions.

Also in this case, the portions in which the two antiferromagnetic layers 11 and 21 and the magnetization fixed layers 12 and 22 are exchange-coupled can be magnetized in the same direction simultaneously.

Therefore, according to this manufacturing method, regardless of the fact that this MR magnetic sensor includes the first and second MR elements 1 and 2, its manufacturing process can be simplified.

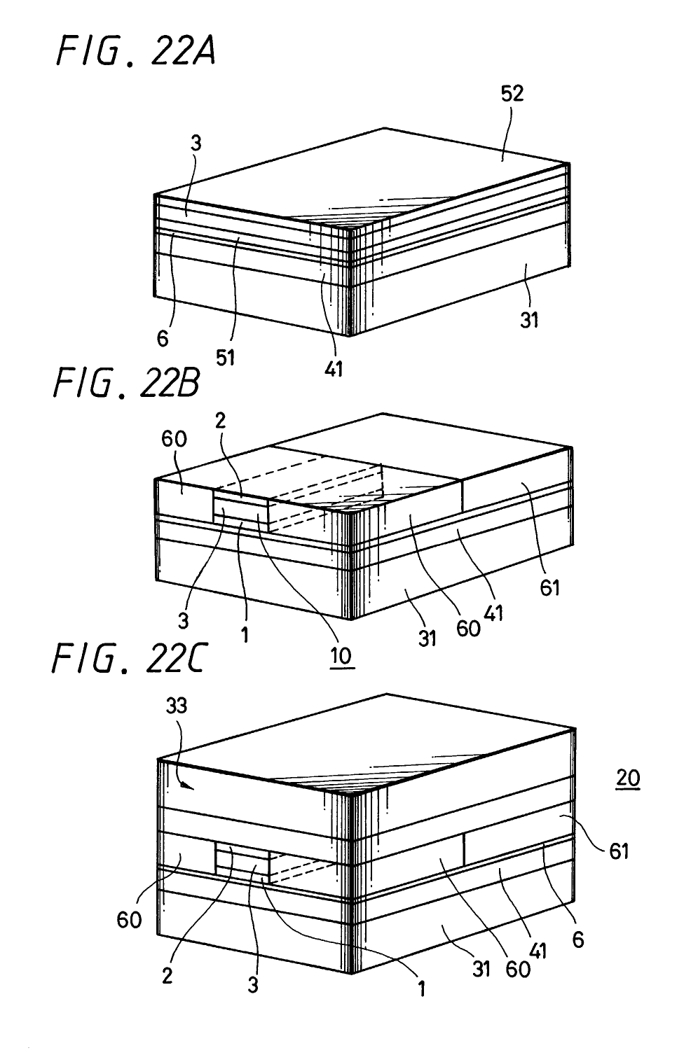

Next, a method of manufacturing an MR head which uses the MR magnetic sensor 10 as a magnetic sensing portion according to an embodiment of the present invention will be described with reference to FIGS. 22A to 22C.

In actual industrial manufacturing methods, a large number of MR heads are simultaneously formed on a common magnetic shield cum electrode 31 of the large area and then they are diced. In FIGS. 22A to 22C, there is illustrated only a portion corresponding to one MR head.

First, as shown in FIG. 22A, the magnetic shield cum electrode 31 made of NiFe having a thickness of approximately 2 μm by plating is prepared on a substrate made of AlTiC, for example. On this magnetic shield and electrode 31, there are sequentially deposited a first nonmagnetic gap layer 41, an underlayer 6, a layer 51 comprising the first MR element 1, a nonmagnetic conductive intermediate layer 3, a layer 52 constituting the second MR element 2 and a protective film (not shown) by continuous sputtering.

In this state, while a magnetic field application and annealing process or a magnetic field generating and annealing process with application of flowing current is being executed, in the layers 51 and 52 constituting the first and second MR element, the antiferromagnetic layer and the magnetization fixed layer which is ferromagnetically exchange-coupled to this antiferromagnetic layer are magnetized.

Thereafter, as shown in FIG. 22B, there is formed the MR magnetic sensor 10 by etching the first and second MR elements 1 and 2 into required patterns, i.e., stripe patterns in the illustrated example, according to a pattern etching treatment, and a stabilizing bias hard magnetic layer 60 is formed on the portion which has been removed by this pattern etching.

As shown in FIG. 22C, a second nonmagnetic gap layer 42 and a second magnetic shield cum electrode 32 are formed on the whole surface, and a front surface 33 which serves as a surface which is brought in contact with or opposed to a suitable medium such as a recording medium from which a detection magnetic field is read out, for example, an ABS is formed by grinding.

In this manner, there is configured a magnetic head 20 which uses this MR magnetic sensor 10 as the magnetic sensing portion.

As an example of the MR magnetic sensor 10, there is illustrated the MR magnetic sensor according to the third embodiment shown in FIG. 20, i.e., the MR magnetic sensor in which the first and second MR elements 1 and 2 have the BDSSV and TSSV configurations.

In this case, the underlayer 6 is comprised of a Ta layer having a thickness of 5 nm and an NiFeCr layer having a thickness of 3 nm.

Then, on this underlayer 6, there is deposited a PtMn layer having a thickness of 15 nm as the first antiferromagnetic layer 11. Subsequently, on this first antiferromagnetic layer 11, there are deposited a first constituent ferromagnetic layer 121 formed of a CoFe layer having a thickness of 2 nm, a magnetic interposed layer 8 formed of an Ru layer having a thickness of 0.9 nm and a second constituent ferromagnetic layer 122 formed of a CoFe layer having a thickness of 2 nm as the first magnetization fixed layer 12. Further, on this first magnetization fixed layer 12, there are deposited a magnetic interposed layer 8 formed of an Ru layer having a thickness of 0.9 nm and a third constituent ferromagnetic layer 123 formed of a CoFe layer having a thickness of 2 nm.

Then, subsequently, there is deposited a first nonmagnetic spacer layer formed of a Cu layer having a thickness of 2.5 nm, for example, on which there is deposited a first magnetization free layer 14 having a lamination layer structure of a CoFe layer having a thickness of 2 nm and an NiFe layer having a thickness of 3 nm.

Subsequently, when a nonmagnetic intermediate gap layer 3 in which a 15 nm long gap length G is formed, a lamination layer structure of a Cu layer having a thickness of 1.5 nm, for example, a Ta layer having a thickness of 7 nm, a Ta layer having a thickness of 5 nm and an Ta layer having a thickness of 5 nm and a Cu layer having a thickness of 1.5 nm serving as an underlayer of the second MR element is deposited on this first magnetization free layer 14.

Subsequently, on this nonmagnetic intermediate gap layer 3, there are deposited a second magnetization free layer 24 having a lamination layer structure of an NiFe layer having a thickness of 3 nm and a CoFe layer having a thickness of 2 nm and a second nonmagnetic spacer layer 23 formed of a Cu layer having a thickness of 2.5 nm. Further, on the second nonmagnetic spacer layer 23, there are deposited first and second constituent ferromagnetic layers 221 and 222, each having a thickness of 2 nm, comprising the second magnetization fixed layer 22 through a nonmagnetic interposed layer 8 formed of an Ru layer having a thickness of 0.9 nm.

Then, on this second magnetization fixed layer 22, there is deposited a PtMn layer having a thickness of 15 nm as the second antiferromagnetic layer 21. Then, a Ta layer having a thickness of 10 nm is deposited on the second antiferromagnetic layer 21 as a protective layer 7.

While the MR magnetic sensor has the stabilizing hard magnetic layer 60 disposed in order to stabilize the magnetization states of the first and second magnetization free layers 14 and 24 in the example shown in FIGS. 22A to 22C, the present invention is not limited thereto and a stabilizing structure based upon the antiferromagnetic layer which effects the long-distance exchange-coupling can be realized with the stabilizing bias hard magnetic layer 60 or without the stabilizing bias hard magnetic layer 60.

In this case, the nonmagnetic intermediate gap layer 3 can be formed as a stabilizing structure based upon a long-distance exchange-coupling to stabilize the magnetization states of the magnetization free layers 14 and 24 under the above-mentioned non-magnetic field state.

That is, in this case, when the first and second MR element structures can be formed as the aforementioned similar film configurations and the nonmagnetic intermediate gap layer 3 has a gal length of 15 nm, an antiferromagnetic layer formed of an IrMn layer having a thickness of 11 nm can be interposed between Cu layers, each having a thickness of 2.0 nm.

In the above-mentioned respective embodiments, the magnetization direction of the magnetization free layer, further, the magnetization direction of the antiferromagnetic layer of the long-distance exchange-coupling to stabilize the magnetization of the magnetization free layer under the above-mentioned non-magnetic field can be set at a temperature of 180° C., for example, with application of a DC magnetic field in which the direction of the magnetic field is rotated 90° after the magnetization direction of the above-mentioned magnetization fixed layer has been set at a temperature of 260° C. with application of the magnetic field.

Moreover, the stabilizing bias hard magnetic layer in the configuration shown in FIGS. 22A to 22C, for example, can be magnetized with application of DC magnetic field finally, for example.

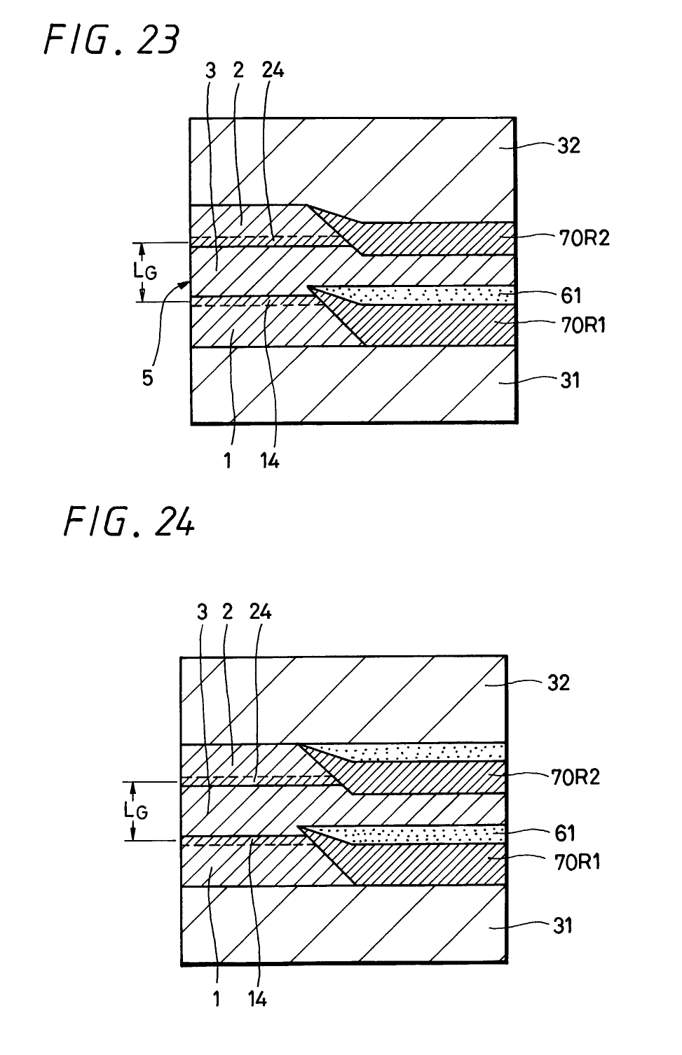

Respective examples in the configurations in which the MR magnetic sensor or the MR magnetic head having the CPP type configuration operates in a differential fashion and which has the flux guide disposed thereat as mentioned before will be described below with reference to respective schematic cross-sectional views of FIGS. 23 to 31. It is, however, needless to say that the present invention is not limited to those examples.

In the respective examples shown in FIGS. 23 and 24, between the first magnetic shield cum electrode 31 and second magnetic shield cum electrode 32, there is disposed the lamination layer structure portion in which the first and second MR elements 1 and 2 having the aforementioned configurations are laminated on the sides of the respective first and second magnetization free layers 14 and 24 through the nonmagnetic intermediate gap layer 3.

Specifically, in this case, the substantial magnetic gap length LG becomes equal to the distance between the centers of the first and second magnetization free layers 14 and 24 opposed to each other through the nonmagnetic intermediate gap layer 3. Hence, the magnetic gap length LG can be selected to be sufficiently small by selecting the thickness of the nonmagnetic intermediate gap layer 3 without being limited by the whole thickness of the first and second MR elements 1 and 2.

Then, in the rear portions of the first and second MR elements 1 and 2, there are disposed first and second rear flux guide layers 70R1 and 70R2 which are magnetically coupled to the respective first and second magnetization free layers 14 and 24 in a so-called abut connection, respectively.

Since the first and second rear flux guide layers 70R1 and 70R2 of high permeability are disposed in the rear portions of the respective magnetization free layers 14 and 24, magnetic flux based upon signal magnetic fields introduced into the respective magnetization free layers 14 and 24 can be led in the rearward effectively. As a result, since this signal magnetic flux is introduced into the whole depths of the respective magnetization free layers 14 and 24, a magnetic flux efficiency can be increased and hence the sensitivity of the MR magnetic sensor or the MR magnetic head can be improved.

Then, the example shown in FIG. 23 exhibits the case in which the first and second rear flux guide layers 70R1 and 70R2 are respectively magnetically coupled to the first magnetic shield cum electrode 31 and second magnetic shield cum electrode 32, each being made of a soft magnetic material, and a magnetic flux return path is formed by the first magnetic shield cum electrode 31 and second magnetic shield cum electrode 32 so that the magnetic flux efficiency can be improved more.

In the configurations shown in FIGS. 23 and 24, when the rear flux guide layers 70R1 and 70R2 are made of materials having a low resistivity, an insulating layer 61 for blocking a sense current, which flows through the first magnetic shield cum electrode 31 and second magnetic shield cum electrode 32, from being shunted into these rear flux guide layers 70R1 and 70R2, is laminated on one or both of the rear flux guide layers 70R1 and 70R2.

However, the present invention is not limited thereto and the lamination of the above-mentioned insulating layer 61 can be omitted by the rear flux guide layers 70R1 and 70R2 made of materials having a high resistivity, such as CoZr-based amorphous material (resistivity ρ : approximately 120 μΩcm), CoXo or FeXo (each X represents Al, Mg, etc.).

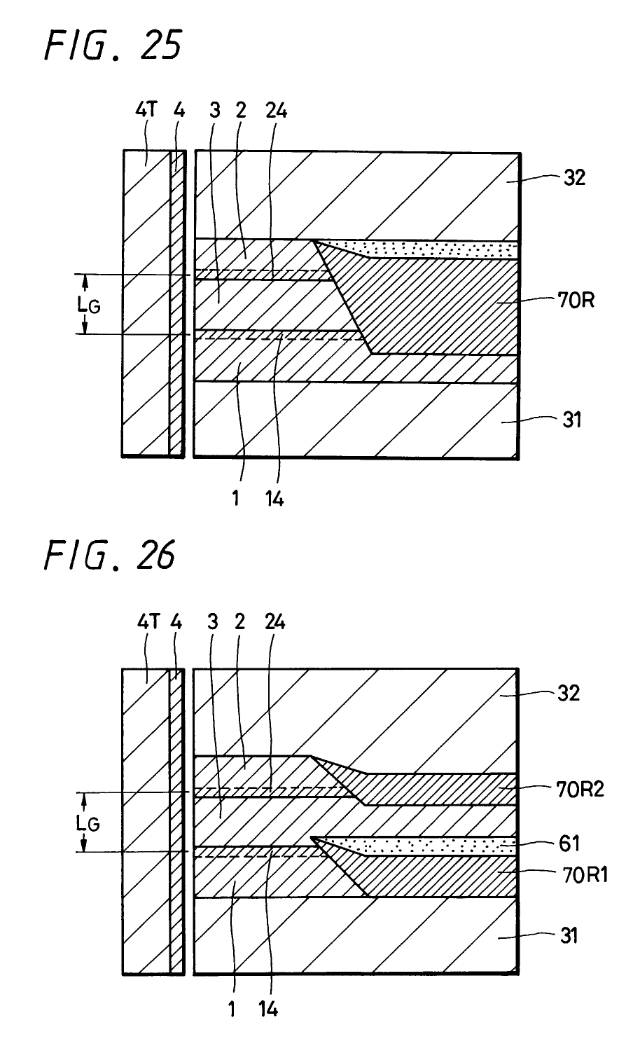

The example shown in FIG. 25 exhibits the case in which the magnetization free layers 14 and 24 of the two MR elements 1 and 2 have a common rear flux guide layer 70R disposed in their rearward portion. The example shown in FIG. 26 exhibits the case in which the magnetization free layers 14 and 24 of the two MR elements have the first and second rear flux guide layers 70R1 and 70R2 disposed in their rearward portions.

In this case, the first magnetic shield cum electrode 31 and second magnetic shield cum electrode 32 can be operated as a magnetic flux return path.

Then, in these examples shown in FIGS. 25 and 26, a high permeability material 4T is lined at the rear surface of a magnetic recording medium of a magnetic signal detected material which is brought in contact with or opposed to the front surface 5 or disk or the high permeability material 4T is disposed in contact with the disk. By this high permeability material 4T, there is formed the return path which passes the two magnetization free layers 14 and 24, whereby magnetic flux based upon the signal magnetic field can pass the whole areas of the two magnetization free layers 14 and 24. Thus, a sensitivity of the MR magnetic sensor or the MR magnetic head can be improved more.

In FIGS. 25 and 26, elements and parts identical to those of FIGS. 23 and 24 are denoted by identical reference numerals and therefore need not be described in detail.

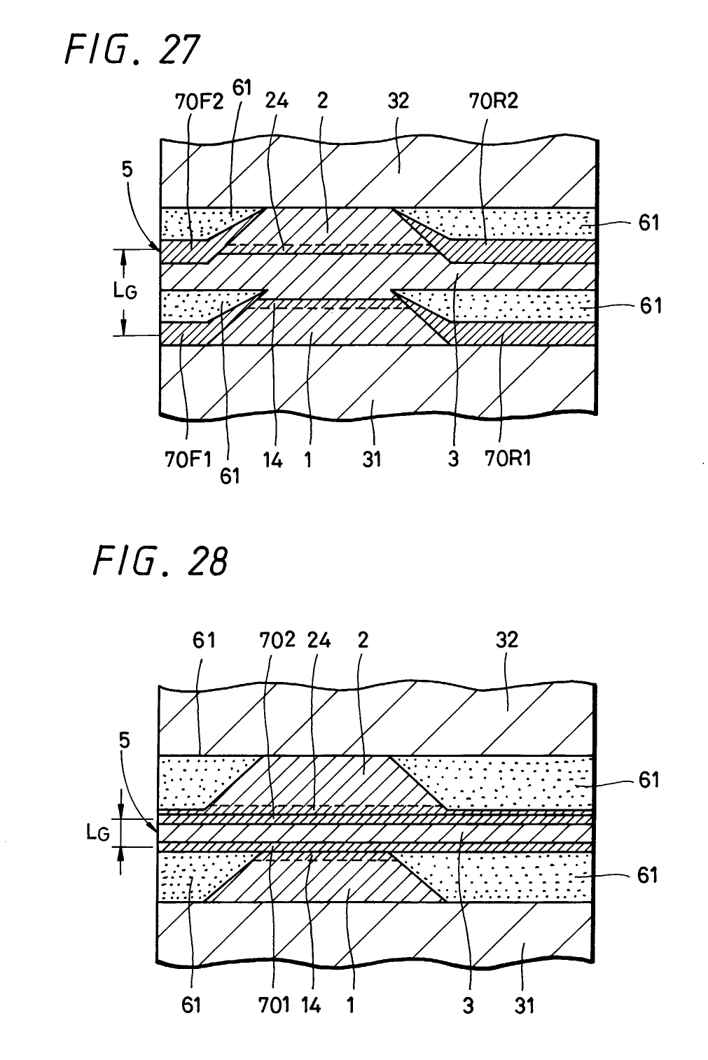

While the rear flux guide layers are disposed in the rearward portion of the magnetization free layers in the above-mentioned examples, the present invention is not limited thereto, and the flux guide layers can be disposed in the front portions of the magnetization free layers as shown in FIGS. 27 to 31.

The example shown in FIG. 27 exhibits the case in which first and second front flux guide layers 70F1 and 70F2, each having a soft magnetic property and a high permeability, are formed in the front portions of the respective first and second magnetization free layers 14 and 24 of the two first and second MR elements 1 and 2 in such a manner that their front ends face the front surface 5. These front flux guide layers 70F1 and 70F2 can be formed at the same time the rear flux guides 70R1 and 70R2, for example, are formed.

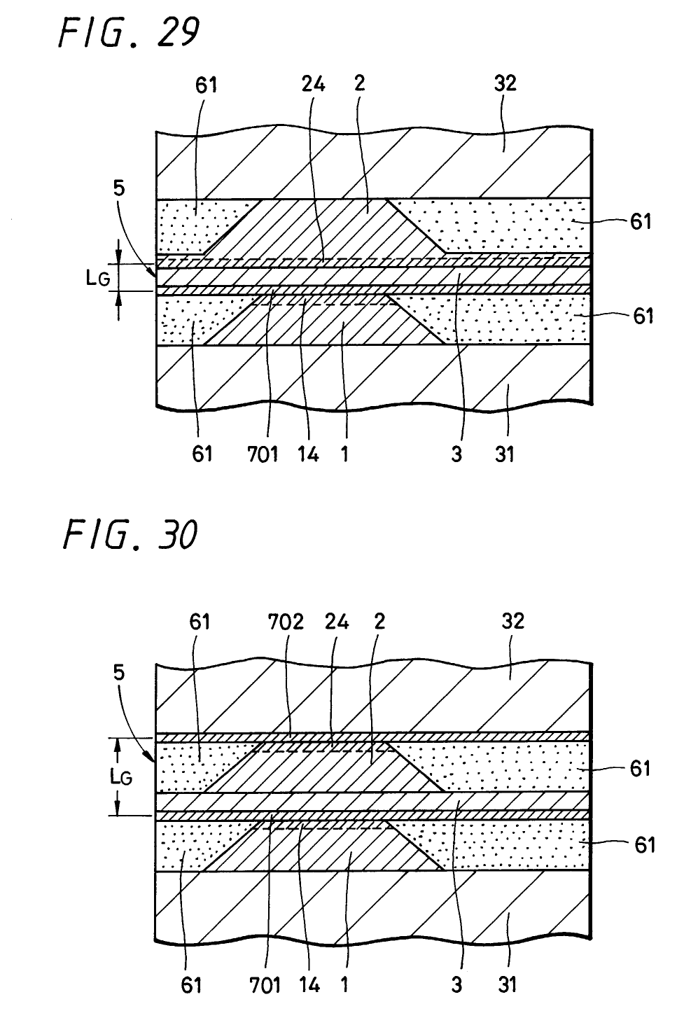

The example shown in FIG. 28 exhibits the case in which conductive first and second flux guides 701 and 702 are disposed on both surfaces of the nonmagnetic intermediate layer 3 in such a manner that they may be brought in contact with the two first and second magnetization free layers 14 and 24 all over the depth of the first and second MR elements 1 and 2. The example shown in FIG. 29 exhibits the case in which the flux guide layer 701 is disposed only on the side of the first magnetization free layer 14.

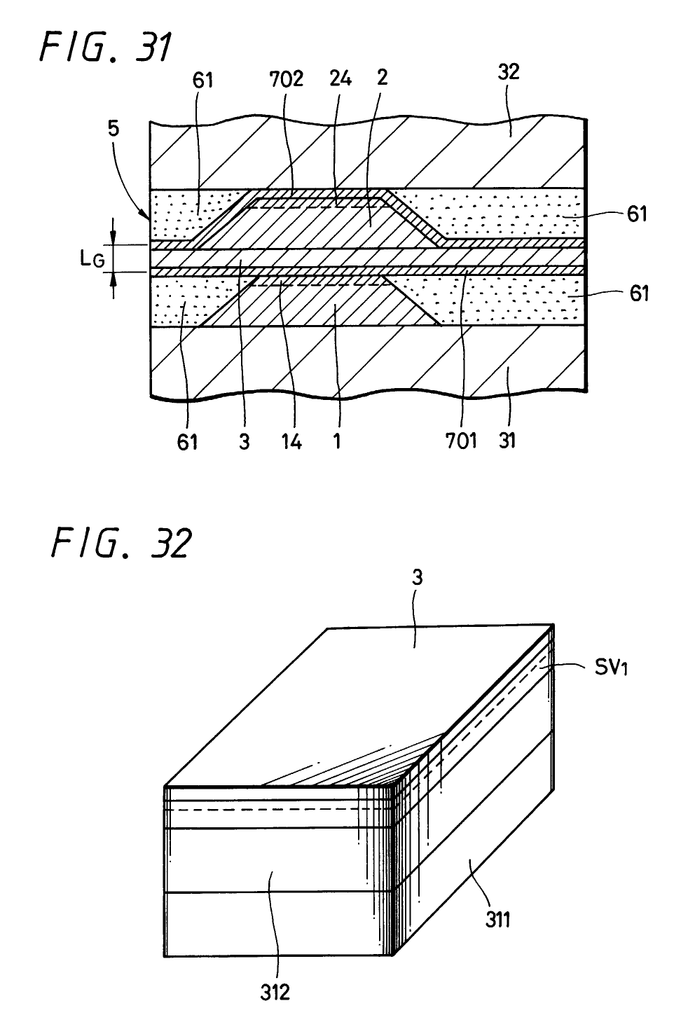

The examples shown in FIGS. 30 and 31 show the cases in which the first and second MR elements 1 and 2 both have the bottom type configurations.

Then, the example shown in FIG. 31 exhibits the case in which the second flux guide layer 702 is brought in contact with the nonmagnetic intermediate gap layer 3 in the front and rear portions to thereby reduce the magnetic gap length LG and is also brought in contact with the second magnetization free layer 24 located at the upper layer position in the second MR element 2.

As described above, when there are disposed the front flux guide layers 70F1 and 70F2 and the flux guide layers 701 and 702 are disposed all over the whole depth, it becomes possible to solve a problem which arises when the first and second MR elements 1 and 2 directly face the front surface 5. For example, when this front surface 5 is produced by grinding, setting of depths of the first and second MR elements 1 and 2 can be prevented from being fluctuated and characteristics of the MR magnetic sensor or the MR magnetic head can be prevented from being deteriorated upon grinding. Further, since the first and second MR elements 1 and 2 can be avoided from being directly exposed to the outside. As a consequence, the life span of the MR magnetic sensor or the MR magnetic head can be extended and the MR magnetic sensor or the MR magnetic head can be operated with high stability.

Then, according to these configurations, the magnetic gap length is prescribed by the spacing between the front flux guide layers 70F1 and 70F2 or the spacing between the centers of the film thicknesses of the flux guide layers 701 and 702. Accordingly, in this case, the layout of the first and second MR elements 1 and 2 is not limited to the above-mentioned layout in which they are opposed to each other on the sides of the magnetization free layers 14 and 24, and the first and second MR elements 1 and 2 are not limited to a combination of the bottom type and top type.

In FIGS. 27 to 31, elements and parts identical to those of FIGS. 23 to 26 are denoted by identical reference numerals and therefore need not be described in detail.

An example of a method of manufacturing an MR magnetic sensor or an MR magnetic head having a structure in which first and second rear flux guide layers are provided and having a CPP configuration in which there is provided a magnetic flux return path will be described below with reference to process diagrams (perspective views) of FIGS. 32 to 41.

While FIGS. 32 to 41 show only one MR magnetic sensor or MR magnetic head, in the actual manufacturing process, a large number of MR magnetic sensors or MR magnetic heads are formed on a common substrate and then they are diced, whereby a plurality of MR magnetic sensors or MR magnetic heads can be manufactured at the same time.

As shown in FIG. 32, a first electrode layer 312, for example, is formed on a return path layer 311 in which a first magnetic shield, for example, can be formed and which is made of a soft magnetic material having a relatively high permeability to comprise the return path. On the first electrode layer 312, there is deposited a spin-valve film SV1 of a bottom type comprising the first MR element 1, i.e., in which the first magnetization free layer 14 is formed on the surface. Then, on the spin-valve film SV1, there is formed a lamination layer portion in which the conductive nonmagnetic spacer layer 3 comprising a thickness of a part of a nonmagnetic intermediate gap layer, which is finally formed according to the need, is formed.

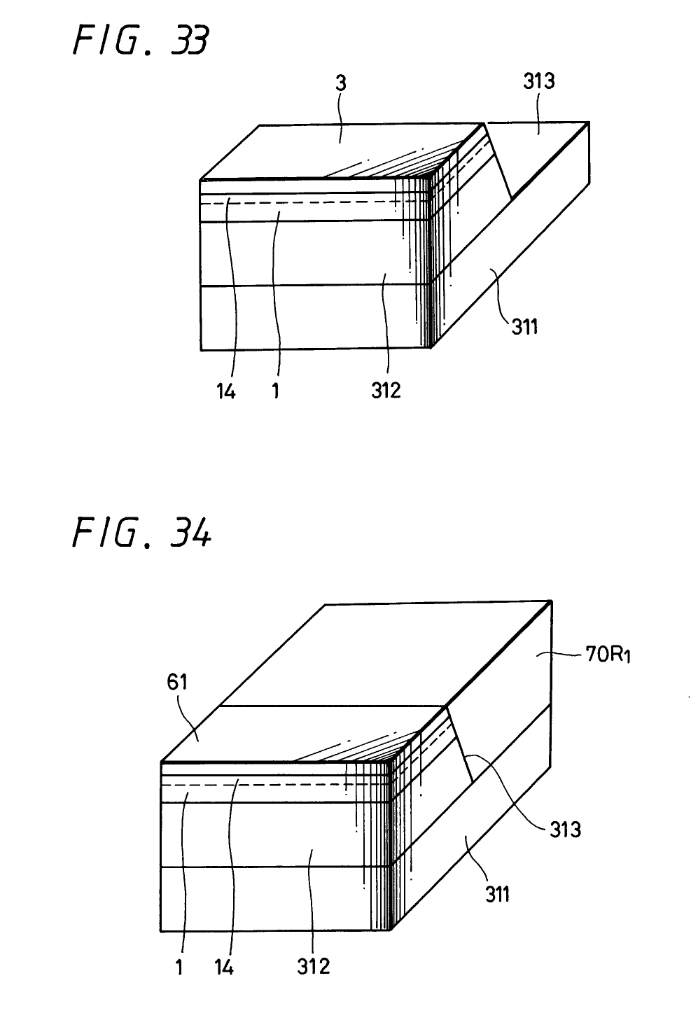

As shown in FIG. 33, the rear portion of this lamination layer portion is pattern-etched from the surface to the depth of the return path 311 by a suitable method such as ion etching using photolithography.

As shown in FIG. 34, a first rear flux guide layer 70R1 is formed in contact with the rear end face of the first magnetization free layer 14 which faces the side surface of a groove 313 so as to fill the groove 313.

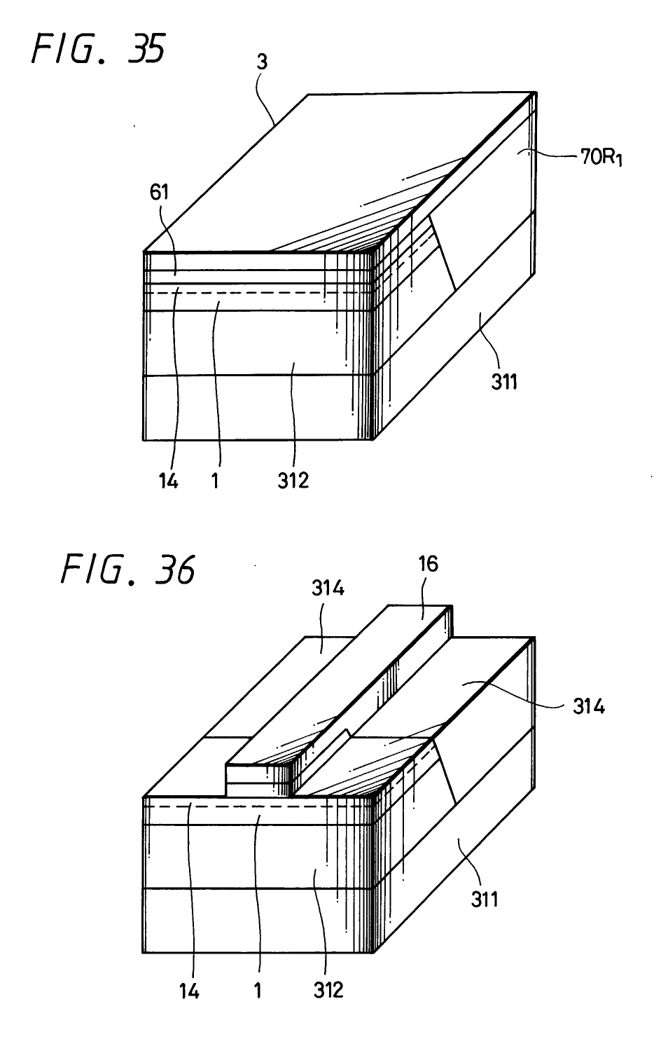

As shown in FIG. 35, there is formed the nonmagnetic intermediate gap layer 3 of the upper layer on the whole surface.

Then, as shown in FIG. 36, the nonmagnetic intermediate gap layer 3 is removed by a suitable method such as ion etching based upon photolithography so as to leave the stripe-like portion in the depth direction and mesa grooves 314 are formed on both sides of the nonmagnetic intermediate gap layer 3.

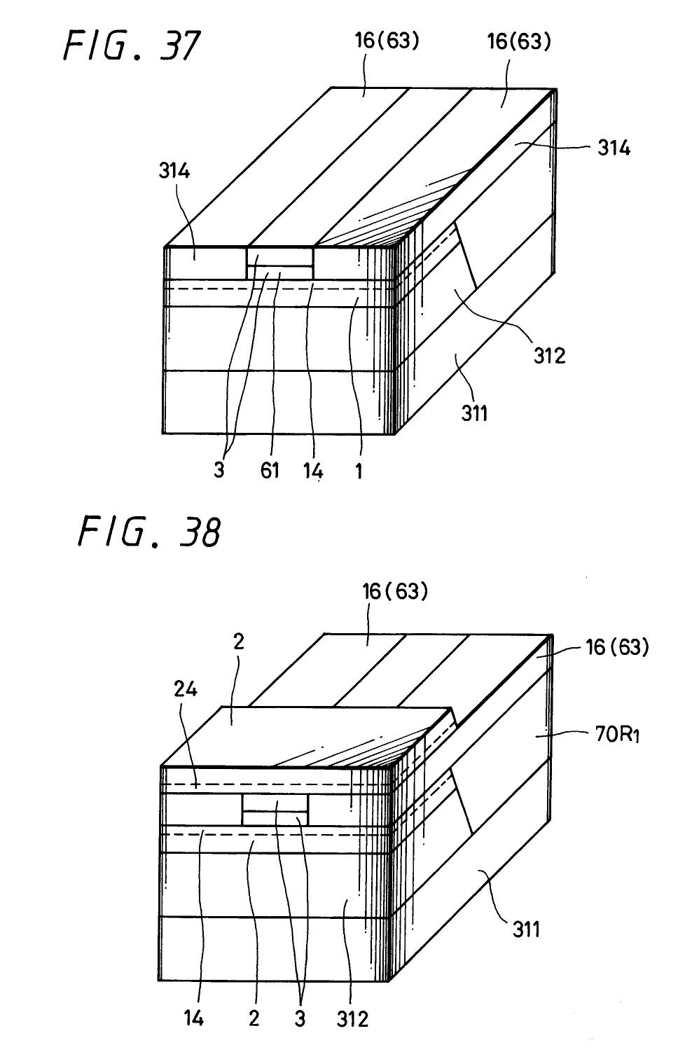

As shown in FIG. 37, there are formed stabilizing bias hard magnetic layers 16 or antiferromagnetic layers 63 for applying a stabilizing bias to the first and second magnetization free layers of the first and second MR elements 1 and 2 within themes a grooves 314 on both sides of the nonmagnetic intermediate gap layer 3.

As shown in FIG. 38, a top type spin-valve film (not shown), for example, is deposited on the whole surface, for example, and this top type spin-valve film is etched away by pattern-etching so as to leave a required depth on the front side. In this manner, the second MR element 2, which is opposed to the first MR element 1, is formed on the nonmagnetic intermediate gap layer 3 and the stabilizing bias hard magnetic layers 16 located on both sides of the nonmagnetic intermediate gap layer 3 or the antiferromagnetic layers 63.

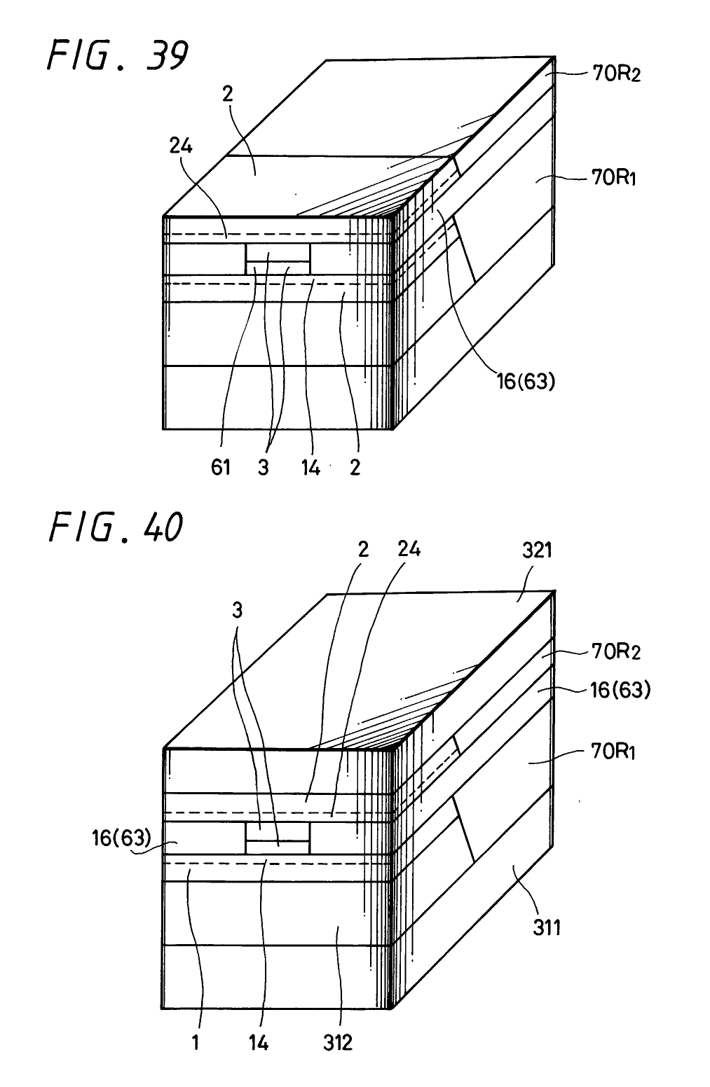

Then, as shown in FIG. 39, the second rear flux guide layer 70R2 is formed in the rearward portion of the second MR element 2.

Thereafter, as shown in FIG. 40, there is formed a second return path 321 made of a soft magnetic material having a high permeability. This return path 321 can also serve as a second electrode.

While the MR magnetic sensor or the MR magnetic head has mainly the CPP configuration in the above-mentioned respective examples, the present invention is not limited thereto and the MR magnetic sensor or the MR magnetic head may have the CIP configuration in the differential operation configuration of the first and second MR elements 1 and 2.

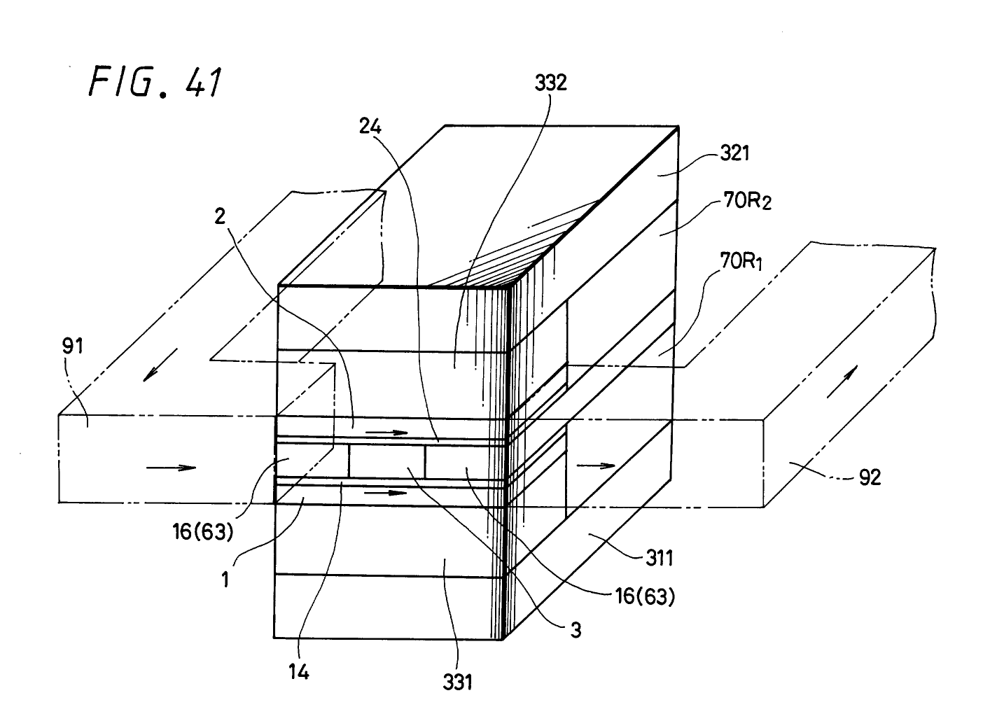

An example of this case is shown in FIG. 41.

In this example, the first and second MR elements 1 and 2 of the bottom type and the top type are formed below and above the insulating nonmagnetic intermediate gap layer 3 having a width which prescribes a predetermined track width in such a manner that the first and second magnetization free layers 14 and 24 may be respectively opposed to each other.

The stabilizing hard magnetic layers 63 or the antiferromagnetic layers 16 for applying the bias magnetic fields to these magnetization free layers 14 and 24 are disposed between the first and second MR elements 1 and 2 and between the first and second magnetization free layers 14 and 24.

The first and second MR elements 1 and 2 have first and second nonmagnetic insulating layers 331 and 332 disposed thereon. Then, first and second rear flux guide layers 70R1 and 70R2 are formed in the rearward portion of the first and second nonmagnetic insulating layers 331 and 332, and first and second return paths 311 and 321 are brought in contact with the first and second rear flux guide layers 70R1 and 70R2.

Then, first and second electrodes 91 and 92 are led out across the first and second magnetization free layers 14 and 24 of the first and second MR elements 1 and 2 and a sense current flows through these first and second electrodes 91 and 92 as shown by arrows in FIG. 41.

In the above-mentioned respective examples, when the magnetic sensor using magneto-resistive effect or the magnetic head using magneto-resistive effect is comprised of the pair of MR elements, various modifications such as a multi-head configuration in which a plurality of heads are arrayed can be taken according to the present invention.

While the magnetic sensor using magneto-resistive effect or the magnetic head using magneto-resistive effect has mainly the SV type GMR configuration in the above-mentioned respective examples, the present invention is not limited thereto and the magnetic sensor using magneto-resistive effect or the magnetic head using magneto-resistive effect may have a tunnel type MR configuration. In this case, in the above-mentioned respective embodiments, the nonmagnetic spacer layers 13 and 23 may be formed as tunnel barrier layers.

Since the magnetic head using magneto-resistive effect according to the present invention is the reproducing head, when the magnetic head using magneto-resistive effect according to the present invention comprises a recording and reproducing magnetic head, a well-known thin-film type electromagnetic induction type recording head, for example, can be integrally formed on the reproducing head formed of the magnetic head using magneto-resistive effect according to the present invention, e.g., on the second magnetic shield cum electrode 32 through an insulating layer.

As described above, since the magnetic sensor using magneto-resistive effect or the magnetic head using magneto-resistive effect according to the present invention is comprised of the first and second magneto-resistive effect elements and generates a differential output between the two output from the first and second magneto-resistive effect elements, there can be obtained the magnetic sensor using magneto-resistive effect or the magnetic head using magneto-resistive effect which can be made high in resolution and which can generate a large output.

In particular, when the first and second magnetic free layers 14 and 24 sides of the first and second magneto-resistive effect elements 1 and 2 are opposed to each other, since the magnetic gap length LG is determined by the distance between the centers of the two magnetization free layers 14 and 24 in the thickness direction, there can be obtained a sufficiently high resolution without being limited by the thickness of the magneto-resistive effect element.

According to the related-art structure, for example, the magnetic gap length is limited to be longer than the thickness of the magneto-resistive effect element, e.g., greater than approximately 30 to 40 nm. However, according to the configuration of the present invention, it becomes possible to form a magnetic gap length of approximately 15 nm, further, a narrow magnetic gap length of approximately several nanometers.

Therefore, a resolution can be improved considerably as compared with the related art, and a recording density in a magnetic recording medium, for example, can be improved.

In the method of manufacturing the magnetic sensor using magneto-resistive effect and the magnetic head using magneto-resistive effect according to the present invention, since the required magnetization is formed in the first and second magneto-resistive effect elements with application of magnetic field in one direction or annealing based upon application of induced magnetic field generated by the flow of current. That is, since the required magnetization is formed in the first and second magneto-resistive effect elements by annealing with application of common magnetic field, its manufacturing method can be simplified.

As described above, since the magnetic sensor using magneto-resistive effect or the magnetic head using magneto-resistive effect according to the present invention is comprised of the first and second magneto-resistive effect elements so that the output of the magnetic sensor using magneto-resistive effect or the magnetic head using magneto-resistive effect is generated as a differential output between the output of the first and second magneto-resistive effect elements, the peak-like reproduced waveform can be obtained in response to the magnetization transition of the recording bits. As a consequence, when a recorded signal is read out from the perpendicular magnetic recording medium, it is possible to avoid the signal processing circuit such as the aforementioned differentiating circuit from being employed. Thus, the S/N can be improved and the circuit configuration can be simplified.

Further, when the lamination layer structure portion of the first and second magneto-resistive effect elements is located in such a manner that the first and second magnetization free layers are opposed to each other through the nonmagnetic intermediate gap layer and their front ends are faced to the front surface of the magnetic sensor using magneto-resistive effect or the magnetic head using magneto-resistive effect, since the magnetic gap length is set by the distance between the centers of the film thickness of the first and second magnetization free layers, this magnetic gap length can be sufficiently reduced without being restricted by the film thicknesses of the magneto-resistive effect elements and hence the resolution can be improved more.

Therefore, the magnetic scale can be made high in accuracy, the recording density of the magnetic recording medium can be increased and the reproduced output can be increased, for example.

Furthermore, in the method of manufacturing the magnetic sensor using magneto-resistive effect and the magnetic head using magneto-resistive effect according to the present invention, since the required magnetization is formed in the first and second magneto-resistive effect elements with application of magnetic field in one direction or annealing based upon application of induced magnetic field generated by flow of current. That is, since the required magnetization is formed in the first and second magneto-resistive effect elements by annealing with application of common magnetic field, its manufacturing method can be simplified, and the mass-productivity can be increased.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A magnetic sensor using magneto-resistive effect comprising:
a lamination layer structure portion of a magneto-resistive effect element in which first and second magneto-resistive effect elements are laminated through a nonmagnetic intermediate gap layer, wherein
a differential output between respective output of said first and second magneto-resistive effect elements is generated as a magnetic sensor output.

2. A magnetic sensor using magneto-resistive effect according to claim 1, wherein said first and second magneto-resistive effect elements of said lamination layer structure portion are given magneto-resistive change characteristics which are opposite to each other in polarity.

3. A magnetic sensor using magneto-resistive effect according to claim 1 or 2, wherein said first and second magneto-resistive effect elements of said lamination layer structure portion are respectively made up of magnetization free layers made of ferromagnetic films whose magnetization directions are changed in response to external magnetic fields, nonmagnetic spacer layers and magnetization fixed layers made of ferromagnetic layers whose magnetization directions are respectively substantially fixed to predetermined directions, which are laminated in that order.

4. A magnetic sensor using magneto-resistive effect according to claim 1, 2 or 3, wherein said first and second magneto-resistive effect elements of said lamination layer structure portion are made up of magnetization free layers made of ferromagnetic layers whose magnetization directions are respectively changed in response to external magnetic fields, nonmagnetic spacer layers, magnetization free layers and antiferromagnetic layers which are ferromagnetically exchange-coupled to said magnetization fixed layers, which are laminated in that order and the magnetization directions of said magnetization fixed layers are fixed by said ferrormagnetic layers.

5. A magnetic sensor using magneto-resistive effect according to claim 3 or 4, wherein said first and second magneto-resistive effect elements of said lamination layer structure portion are laminated in such a fashion that said magnetization free layers thereof are opposed to each other through said nonmagnetic intermediate gap layers.

6. A magnetic sensor using magneto-resistive effect according to claim 4 or 5, wherein said magnetization fixed layer of one of said first and second magneto-resistive effect elements of said lamination layer structure portion includes a single ferromagnetic layer or a lamination layer structure formed of a plurality of ferromagnetic layers of layers of an odd number of which the magnetic moment directions are nearly coupled with each other in an anti-parallel fashion, said magnetization fixed layer of the other magneto-resistive effect element includes a lamination layer structure formed of ferromagnetic layers of layers of an even number of which the magnetization directions are coupled nearly in an anti-parallel fashion and the magnetization directions of said respective antiferromagnetic layers, which are ferromagnetically exchange-coupled to said magnetization fixed layers, of said first and second magneto-resistive effect elements are set to nearly the same directions.

7. A magnetic sensor using magneto-resistive effect according to claim 4 or 5, wherein said first and second magneto-resistive effect elements are respectively magneto-resistive effect elements including antiferrormagnetic layers, magnetization fixed layers and magnetization fixed layers, both of the magnetization fixed layers of said first and second magneto-resistive effect elements include lamination layer structures based upon a single layer structure of a ferromagnetic layer or a plurality of ferromagnetic layer structures of layers of an odd number of which magnetic moment directions are coupled to each other in nearly an anti-parallel fashion or ferromagnetic layer structures of layers of an even number of which the magnetization moment directions are coupled to each other in an anti-parallel fashion and the magnetization directions of respective antiferromagnetic layers, which are ferromagnetically exchange-coupled to said magnetization fixed layers, of said first and second magneto-resistive effect elements are set to anti-parallel directions.

8. A magnetic sensor using magneto-resistive effect according to claim 4, 6 or 7, wherein said antiferromagnetic layers of said first and second magneto-resistive effect elements are different from each other in composition.

9. A magnetic sensor using magneto-resistive effect according to claim 4, 6, 7 or 8, wherein said antiferromagnetic layers of said first and second magneto-resistive effect elements are different from each other in thickness.

10. A magnetic sensor using magneto-resistive effect according to claim 1, 2, 3, 4, 5, 6, 7, 8 or 9, wherein said magnetic sensor using magneto-resistive effect has a current perpendicular to plane type configuration in which first and second electrode layers are formed across said lamination layer structure portion and current flows through said first and second electrode layers in the direction extending along the lamination layer direction of said lamination layer structure portion.

11. A magnetic sensor using magneto-resistive effect according to claim 1, 2, 3, 4, 5, 6, 7, 8, 9 or 10, wherein said lamination layer structure portion has a flux guide disposed at least in either its forward or rearward portion.

12. A magnetic sensor using magneto-resistive effect according to claim 11, further comprising closed magnetic paths which, passing through both of said first and second magnetization free layers are formed such that said flux guide is used as a part of a magnetic path.

13. A magnetic sensor using magneto-resistive effect according to claim 1, wherein said first and second magneto-resistive effect elements have magneto-resistive change characteristics which are the same in polarity and a differential output between output from said first and second magneto-resistive effect elements is generated as a magnetic sensor output from a circuit standpoint.

14. A magnetic head using magneto-resistive effect including a magnetic sensor using magneto-resistive effect for detecting a signal magnetic field based upon recorded information from a perpendicular magnetic recording medium, wherein,
said magnetic sensor using magneto-resistive effect includes
a magneto-resistive effect element lamination layer structure portion in which first and second magneto-resistive effect elements are laminated through a nonmagnetic intermediate gap layer and
a differential output between output from said first and second magneto-resistive effect elements is generated as a magnetic sensor output.

15. A magnetic head using magneto-resistive effect according to claim 14, wherein said first and second magneto-resistive effect elements of said lamination layer structure portion have magneto-resistive change characteristics which are opposite to each other in polarity.

16. A magnetic head using magneto-resistive effect according to claim 14 or 15, wherein said first and second magneto-resistive effect elements of said lamination layer structure portion are made up of magnetization free layers made of ferromagnetic films of which the magnetization directions are respectively changed in response to an external magnetic field, nonmagnetic spacer layers and magnetization fixed layers made of ferromagnetic layers of which the magnetization directions are respectively substantially fixed to predetermined directions, which are laminated in that order.

17. A magnetic head using magneto-resistive effect according to claim 14, 15 or 16, wherein said first and second magneto-resistive effect elements of said lamination layer structure portion are made up of magnetization free layers made of ferromagnetic films of which the magnetization directions are respectively changed in response to an external magnetic field, nonmagnetic spacer layers, magnetization fixed layers and antiferromagnetic layers, ferromagnetically exchange-coupled to the magnetization fixed layers, which are laminated in that order, and the magnetization direction of said magnetization fixed layers are fixed by said antiferromagnetic layers.

18. A magnetic head using magneto-resistive effect according to claim 16 or 17, wherein said first and second magneto-resistive effect elements of said lamination layer structure portion are laminated in such a manner that their magnetization free layers are opposed to each other through said nonmagnetic intermediate gap layers, respectively.

19. A magnetic head using magneto-resistive effect according to claim 17 or 18, wherein said magnetization fixed layer of any one of said first and second magneto-resistive effect elements of said lamination layer structure portion includes a lamination layer structure of a single ferromagnetic layer or a plurality of ferromagnetic layers of an odd number of layers of which the magnetic moment directions are coupled in a nearly anti-parallel fashion,
said magnetization fixed layer of the other magneto-resistive effect element includes a lamination layer structure of ferromagnetic layers of an even number of layers of which the magnetization directions are coupled in a nearly anti-parallel fashion, and the magnetization directions of respective antiferromagnetic layers of said first and second magneto-resistive effect elements as are ferromagnetically exchange-coupled to said magnetization fixed layers are set to substantially the same directions.

20. A magnetic head using magneto-resistive effect according to claim 17 or 18, wherein said first and second magneto-resistive effect elements are magneto-resistive effect elements including antiferromagnetic layers, magnetization fixed layers and magnetization free layers,
the magnetization fixed layers of said first and second magneto-resistive effect elements both including lamination layer structures made up of single layer structures of ferromagnetic layers or lamination layer structures made up of a plurality of ferromagnetic layer structures of an odd number of layers in which directions of magnetic moments are coupled to each other in a nearly anti-parallel fashion or lamination layer structures made up of ferromagnetic layer structures of an even number of layers in which directions of magnetic moments are coupled to each other in an anti-parallel fashion, and
magnetization directions of respective antiferromagnetic layers of said first and second magneto-resistive effect elements as are ferromagnetically exchange-coupled to said magnetization fixed layers being set to nearly anti-parallel directions.

21. A magnetic head using magneto-resistive effect according to claim 17, 19 or 20, wherein said antiferromagnetic layers of said first and second magneto-resistive effect elements are different from each other in composition.

22. A magnetic head using magneto-resistive effect according to claim 17, 19, 20 or 21, wherein said antiferromagnetic layers of said first and second magneto-resistive effect elements are different from each other in thickness.

23. A magnetic head using magneto-resistive effect according to claim 14, 15, 16, 17, 18, 19, 20, 21 or 22, wherein said magnetic head using magneto-resistive effect has a current perpendicular to plane type configuration in which first and second electrode layers are formed across said lamination layer structure portion and current flows through said first and second electrode layers in the direction extending along the lamination layer direction of said lamination layer structure portion.

24. A magnetic head using magneto-resistive effect according to claim 14, 15, 16, 17, 18, 19, 20, 21, 22 or 23, wherein said lamination layer structure portion has a flux guide disposed at least in either the forward or rearward portion thereof.

25. A magnetic head using magneto-resistive effect according to claim 24, further comprising closed magnetic paths which pass through said first and second magnetization free layers while said flux guide is used as a part of magnetic path.

26. A magnetic head using magneto-resistive effect according to claim 14, 15, 16, 17, 18, 19, 20, 21, 22, 24 or 25, wherein a film plane of said magnetic sensor is so disposed as to be nearly perpendicular to the surface of the magnetic recording medium and said nonmagnetic intermediate gap layer is relatively thinly formed compared with a rearward portion on the surface at which it is opposed to said magnetic recording medium.

27. A magnetic head using magneto-resistive effect according to claim 18, wherein a film plane of said magnetic sensor is so disposed as to be nearly perpendicular to the surface of the magnetic recording medium and
said nonmagnetic intermediate gap layer and the tip ends of the magnetization free layers of the adjacent first and second magneto-resistive effect elements provided across said nonmagnetic intermediate gap layer are projected forward from the magnetization fixed layers and the nonmagnetic spacer layers of said first and second magneto-resistive effect elements.

28. A magnetic reproducing apparatus including a magnetic head using magneto-resistive effect having a magnetic sensor for detecting signal magnetic fields of recorded information from a perpendicular magnetic recording medium, wherein
said magnetic sensor using magneto-resistive effect includes
a lamination layer structure portion of a magneto-resistive effect element in which first and second magneto-resistive effect elements are laminated through a nonmagnetic intermediate gap layer and
a differential output between respective output of said first and second magneto-resistive effect elements is generated as a magnetic sensor output.

29. A magnetic reproducing apparatus according to claim 28, wherein said first and second magneto-resistive elements of said lamination layer structure portion have magneto-resistive change characteristics which are opposite toe each other in polarity.

30. A magnetic reproducing apparatus according to claim 28 or 29, wherein said first and second magneto-resistive effect elements of said lamination layer structure portion are comprised of magnetization free layers made up of ferromagnetic films of which the magnetization directions are respectively changed in response to external magnetic fields, nonmagnetic spacer layers and magnetization fixed layers made up of ferromagnetic layers of which the magnetization directions are respectively substantially fixed to predetermined directions, which are laminated in that order.

31. A magnetic reproducing apparatus according to claim 28, 29 or 30, wherein said first and second magneto-resistive effect elements of said lamination layer structure portion are comprised of magnetization free layers made up of ferromagnetic films of which the magnetization directions are respectively changed in response to external magnetic fields, nonmagnetic spacer layers, magnetization fixed layers and antiferromagnetic layers which are ferromagnetically exchange-coupled to said magnetization fixed layers, which are laminated in that order, and the magnetization directions of said magnetization fixed layers are fixed by said antiferromagnetic layers.

32. A magnetic reproducing apparatus according to claim 30 or 31, wherein said first and second magneto-resistive effect elements of said lamination layer structure portion are laminated in such a manner that their magnetization free layer sides are opposed to each other through said nonmagnetic intermediate gap layers.

33. A magnetic reproducing apparatus according to claim 31 or 32, wherein said magnetization fixed layer of one of said first and second magneto-resistive effect elements of said lamination layer structure portion includes a lamination layer structure of single ferromagnetic layers or a plurality of ferromagnetic layers of an odd number of layers of which the magnetic moment directions are coupled to each other in a nearly anti-parallel fashion,
said magnetization fixed layer of the other magneto-resistive effect element includes a lamination layer structure of an even number of ferromagnetic layers of which the magnetization directions are coupled to each other in a nearly anti-parallel fashion and
the magnetization directions of respective antiferromagnetic layers of said first and second magneto-resistive effect elements as are ferromagnetically exchange-coupled to said magnetization fixed layers are set to substantially the same directions.

34. A magnetic reproducing apparatus according to claim 31 or 32, wherein said first and second magneto-resistive effect elements are magneto-resistive effect elements including antiferromagnetic layers, magnetization fixed layers and magnetization free layers
the magnetization fixed layers of said first and second magneto-resistive effect elements both include lamination layer structures made up of single layer structures of ferromagnetic layers or made up of a plurality of ferromagnetic layer structures of an odd number of layers in which magnetic moment directions are coupled to each other in a nearly anti-parallel fashion or lamination layer structures made up of an even number of layers of ferromagnetic layer structures in which magnetic moment directions are coupled to each other in a nearly anti-parallel fashion and the magnetization directions of respective antiferromagnetic layers of said first and second magneto-resistive effect elements as are ferromagnetically exchange-coupled to each magnetization fixed layers in a nearly anti-parallel fashion.

35. A magnetic reproducing apparatus according to claim 31, 33 or 34, wherein said antiferromagnetic layers of said first and second magneto-resistive effect elements are different from each other in composition.

36. A magnetic reproducing apparatus according to claim 31, 33, 34 or 35, wherein said ant-ferromagnetic layers of said first and second magneto-resistive effect elements are different from each other in thickness.

37. A magnetic reproducing apparatus according to claim 28, 29, 30, 31, 32, 33, 34, 35 or 36, wherein said magnetic reproducing apparatus has a current perpendicular to plane configuration in which first and second electrode layers are formed across said lamination layer structure portion and a current flows through said first and second electrode layers in the direction extending along the lamination layer direction of said lamination layer structure portion.

38. A magnetic reproducing apparatus according to claim 28, 29, 30, 31, 32, 33, 34, 35, 36 or 37, wherein said lamination layer structure portion has a flux guide located at least in either its front portion or its rear portion.

39. A magnetic reproducing apparatus according to claim 38, further comprising a closed magnetic path formed so as to pass both of said first and second magnetization free layers by using said flux guide as a part of a magnetic path.

40. A magnetic reproducing apparatus according to claim 28, 29, 30, 31, 32, 33, 34, 35, 36, 37 or 38, wherein a film plane of said magnetic sensor is so disposed as to be nearly perpendicular to the magnetic recording medium surface and said nonmagnetic intermediate gap layer is relatively thinly formed compared with a rearward portion on the surface at which it is opposed to said magnetic recording medium.

41. A magnetic reproducing apparatus according to claim 32, wherein a film plane of said magnetic sensor is so disposed as to be nearly perpendicular to the magnetic recording medium surface and said nonmagnetic intermediate gap layer and said adjacent first and second magnetization free layers located across said nonmagnetic intermediate gap layer have tip ends projected forward from the first and second magnetization fixed layers and said first and second nonmagnetic spacer layers.

42. A method of manufacturing a magnetic sensor using magneto-resistive effect including a lamination layer structure portion in which first and second magneto-resistive effect elements are laminated through a nonmagnetic intermediate gap layer, comprising the steps of:
a film deposition process in which said first magneto-resistive effect element, said nonmagnetic intermediate gap layer and said second magneto-resistive effect element are deposited, in that order; and
a process in which magneto-resistive effect change characteristics of said first and second magneto-resistive effect elements are made opposite to each other in polarity by the following annealing with application of a magnetic field in one direction.

43. A method of manufacturing a magnetic sensor using magneto-resistive effect including a lamination layer structure portion in which first and second magneto-resistive effect elements are laminated to each other through a nonmagnetic intermediate gap layer, comprising the steps of:
a film deposition process in which said first magneto-resistive effect element, said nonmagnetic intermediate gap layer and said second magneto-resistive effect element are deposited, in that order; and
a process in which magneto-resistive effect change characteristics of said first and second magneto-resistive effect elements are made opposite to each other in polarity by the following annealing with application of a magnetic field based upon application of induced magnetic field generated when a current is flowing through said first and second magneto-resistive effect elements in one direction.

44. A method of manufacturing a magnetic head using magneto-resistive effect including a magnetic sensor using magneto-resistive effect for detecting a signal magnetic field based upon recorded information from a perpendicular magnetic recording medium and said magnetic sensor using magneto-resistive effect including a magneto-resistive effect element lamination layer structure portion in which first and second magneto-resistive effect elements are laminated to each other through a nonmagnetic intermediate gap layer, comprising the steps of:
a film deposition process in which said first magneto-resistive effect element, said nonmagnetic intermediate gap layer and said magneto-resistive effect element are deposited, in that order; and
a process in which magneto-resistive effect change characteristics of said first and second magneto-resistive effect elements are made opposite to each other in polarity by the following annealing with application of a magnetic field in one direction.

45. A method of manufacturing a magnetic head using magneto-resistive effect including a magnetic sensor using magneto-resistive effect for detecting a signal magnetic field based upon recorded information from a perpendicular magnetic recording medium and wherein said magnetic sensor using magneto-resistive effect includes a lamination layer structure portion of a magneto-resistive effect element in which first and second magneto-resistive effect elements are laminated to each other through a nonmagnetic intermediate gap layer, comprising the steps of:
a film deposition process in which said first magneto-resistive effect element, said nonmagnetic intermediate gap layer and said second magneto-resistive effect element are deposited, in that order; and
a process in which said first and second magneto-resistive effect elements have magneto-resistive effect change characteristics made opposite in polarity by annealing with application of magnetic fields generated when an induced magnetic field is applied to said first and second magneto-resistive effect elements in one direction.
